(19) United States
(12) Patent Application Publication
(10) Pub. No.: US 2017/0017118 A1
(43) Pub. Date: Jan. 19, 2017

(54) LIQUID CRYSTAL PANEL, LIQUID CRYSTAL DISPLAY DEVICE, POLARIZING PLATE, AND POLARIZING PLATE PROTECTIVE FILM

(71) Applicant: FUJIFILM Corporation, Tokyo (JP)

(72) Inventors: Takashi YONEMOTO, Kanagawa (JP); Yukito SAITOH, Kanagawa (JP)

(73) Assignee: FUJIFILM Corporation, Tokyo (JP)

(21) Appl. No.: 15/277,333

(22) Filed: Sep. 27, 2016

Related U.S. Application Data
(63) Continuation of application No. PCT/JP2015/059710, filed on Mar. 27, 2015.

(30) Foreign Application Priority Data
Mar. 28, 2014 (JP) 2014-070576

(51) Int. Cl. G02F 1/1335; F21V 8/00; G02F 1/13363

(52) U.S. Cl. CPC G02F 1/133536; G02F 1/133504; G02F 1/13363; G02B 6/005; G02F 2202/36; G02F 2001/133507; G02F 2001/133567; G02F 2001/133638; G02F 2203/05

(57) ABSTRACT

One embodiment of the present invention relates to a liquid crystal panel including a liquid crystal panel member including a visible side polarizer, a liquid crystal cell, and a backlight side polarizer; and an optical conversion member including an optical conversion layer containing a quantum dot emitting fluorescent light which is excited by incident excitation light, in which the optical conversion member is integrally laminated on a backlight side surface of the liquid crystal panel member, a liquid crystal display device, a polarizing plate, and a polarizing plate protective film.

### CROSS-REFERENCE TO RELATED APPLICATIONS

This application is a Continuation of PCT International Application No. PCT/JP2015/59710 filed on Mar. 27, 2015, which claims priority under 35 U.S.C §119(a) to Japanese Patent Application No. 2014-070576 filed on Mar. 28, 2014. Each of the above applications is hereby expressly incorporated by reference, in its entirety.

### BACKGROUND OF THE INVENTION

1. Field of the Invention

The present invention relates to a liquid crystal panel, and specifically, relates to a liquid crystal panel capable of providing a liquid crystal display device in which the occurrence of color unevenness is suppressed.

Further, the present invention relates to a liquid crystal display device including the liquid crystal panel described above, and a polarizing plate and a polarizing plate protective film which are able to be used in the liquid crystal panel described above.

2. Description of the Related Art

A flat panel display such as a liquid crystal display device (hereinafter, also referred to as LCD) has been widely used annually as a space saving image display device having low power consumption.

In the flat panel display market, improvements in color reproducibility have progressed as improvement in LCD performance. In this point, recently, a quantum dot (also referred to as QD) has attracted attention as a light emission material (refer to US2012/0113672A1). For example, in a case where excitation light is incident on a layer containing a quantum dot from a backlight, the quantum dot is excited and emits fluorescent light. Here, by using the quantum dots having different light emission properties, white light is able to be embodied by emitting each bright line light of red light, green light, and blue light. The fluorescent light of the quantum dot has a small half-width, and thus, the obtained white light has a high brightness and an excellent color reproducibility. According to the progress of three-wavelength light source technology using such a quantum dot, a color reproduction range has widened to 100% from 72% of the current TV standard (Full High Definition (FHD), National Television System Committee (NTSC)) ratio.

### SUMMARY OF THE INVENTION

As described above, the quantum dot is a useful material which is able to improve the performance of LCD according to the improvement in the color reproducibility. For this reason, in the related art, it has been proposed that an optical conversion member containing a quantum dot is incorporated in a backlight unit, and more specifically, the optical conversion member containing a quantum dot, is arranged on the backlight unit on a liquid crystal panel side. However, as a result of studies of the present inventors, it has been found that in the liquid crystal display device including the backlight unit in which the optical conversion member containing a quantum dot is arranged on the liquid crystal panel side, color unevenness occurs after conveyance, storage, or the like under a high temperature and high humidity environment.

Therefore, an object of the present invention is to provide means for suppressing the occurrence of color unevenness in a liquid crystal display device including an optical conversion member containing a quantum dot.

The present inventors have conducted studies in order to attain the object described above, and have concluded that the color unevenness described above occurs by bringing the backlight side surface of the liquid crystal panel into contact with the optical conversion member of the backlight unit. This point will be further described.

The liquid crystal display device is configured of at least a backlight, and a liquid crystal cell, and further includes a member such as a backlight side polarizer and a visible side polarizer. The optical conversion member containing a quantum dot is included as a configuration member of the backlight. More specifically, the optical conversion member containing a quantum dot is disposed in the backlight by having a space with respect to the liquid crystal panel.

However, when the polarizer absorbs moisture under a high temperature and high humidity environment, and then, the liquid crystal display device is left to stand under a normal temperature and normal humidity environment, the liquid crystal panel is warped. It is considered that this is mainly due to the following reasons.

In general, the polarizer is prepared by stretching a film, and the visible side polarizer and the backlight side polarizer are bonded to the liquid crystal cell in a direction which is orthogonal to a stretching direction. As a result thereof, it is considered that the visible side polarizer and the backlight side polarizer which absorb moisture under a high temperature and high humidity environment, and then, are left to stand under normal temperature and normal humidity environment, as described above, respectively exhibit different contractile forces, and thus, cause the liquid crystal panel to be warped. Then, when the liquid crystal panel is warped to the backlight side, the optical conversion member which is arranged on the backlight side surface of the liquid crystal panel and the liquid crystal panel side of the backlight is partially in contact with the liquid crystal panel. It is necessary that the optical conversion member containing a quantum dot extracts light emitted in an optical conversion member, but a difference in the extraction efficiency between a contact portion and a non-contact portion occurs. More specifically, in the contact portion, air is not interposed between the optical conversion member and the liquid crystal panel, and thus, extraction efficiency locally increases, compared to the non-contact portion in which air is interposed. Thus, it is assumed that extraction unevenness in internal light emission occurs on the exit surface side of the optical conversion member, and thus, causes the occurrence of color unevenness.

Therefore, as a result of more intensive studies of the present inventors based on the new findings described above, it has been found that the optical conversion member which has been used as the configuration member of the backlight unit in the related art is integrally laminated on the backlight side surface of the liquid crystal panel as the configuration member of the liquid crystal panel, and thus, the occurrence of color unevenness is able to be suppressed, and the present invention has been completed.

One aspect of the present invention relates to a liquid crystal panel, comprising: a liquid crystal panel member including a visible side polarizer, a liquid crystal cell, and a backlight side polarizer; and an optical conversion member including an optical conversion layer containing a quantum dot emitting fluorescent light which is excited by incident excitation light, in which the optical conversion member is integrally laminated on a backlight side surface of the liquid crystal panel member. Here, in the present invention, the optical conversion member being “integrally laminated” on the surface of the liquid crystal panel member is used as the meaning excluding a state where the optical conversion member is simply arranged on the liquid crystal panel member without using adhesion, pressure sensitive adhesion, or coating formation. For example, a state where the surface of the liquid crystal panel member adheres to the surface of the optical conversion member by an interlayer bonding two layers, such as an easily adhesive layer and a pressure sensitive adhesive layer, a state where the surface of the liquid crystal panel member adheres to the surface of the optical conversion member by lamination processing using an adhesive or lamination processing not using an adhesive (thermal pressure bonding), a state where the optical conversion member is formed by being applied on the surface of the liquid crystal panel member (more specifically, the optical conversion member is formed by applying a coating liquid for forming an optical conversion member onto the surface of the liquid crystal panel member, and then, by performing a treatment such as drying, and as necessary, curing), and the like are included in the meaning of “integrally laminated”. By being integrally laminated as described above, air does not exist on the boundary surface between the liquid crystal panel member and the optical conversion member, and thus, for example, even in a case where the liquid crystal panel is warped due to the deformation of the backlight side polarizing plate, it is possible to prevent the occurrence of a phenomenon in which the liquid crystal panel is partially in contact with the optical conversion member. Accordingly, it is possible to suppress the occurrence of color unevenness in a liquid crystal display device including the optical conversion member.

In addition, in the polarizing plate described below, the polarizer and the optical conversion member being “integrally laminated” are used as the meaning excluding a state where the optical conversion member is simply arranged on the polarizer, or a member including the polarizer (for example, a laminate of a polarizer and a protective film) without using adhesion, pressure sensitive adhesion, or coating formation. Aspects of integral lamination are as described above.

In one aspect, the optical conversion member described above includes at least one barrier layer.

In one aspect, the liquid crystal panel further comprises a brightness enhancement film, and the backlight side polarizer, the brightness enhancement film, and the optical conversion layer are provided in this order. By including the brightness enhancement film, it is possible to provide a liquid crystal display device which is able to display an image having higher brightness. In addition, the brightness is adjusted by reducing the number of LEDs mounted on a backlight unit, or the like, and thus, power consumption is able to be reduced in the same brightness conditions.

In one aspect, the brightness enhancement film includes a reflection polarizer including a cholesteric liquid crystal layer allowing circularly polarized light to exit, and further includes a λ/4 plate between the reflection polarizer and the backlight side polarizer.

In one aspect, the brightness enhancement film includes a reflection polarizer allowing linearly polarized light to exit.

In one aspect, the brightness enhancement film includes an optically functional layer performing light condensation or diffusion by refracting incidence light.

In one aspect, the liquid crystal panel includes two or more brightness enhancement films.

In one aspect, the liquid crystal cell includes two substrates, and a liquid crystal layer positioned between the two substrates, and each of the two substrates has a thickness of less than or equal to 0.3 mm. The liquid crystal cell is easily warped due to the deformation of the polarizing plate as the substrate included in the liquid crystal cell becomes thinner, but as described above, the liquid crystal panel member and the optical conversion member are integrally laminated, and thus, even in a case where the liquid crystal cell is warped, it is possible to prevent the surface of the liquid crystal panel from being partially in contact with the optical conversion member, and therefore, it is possible to suppress the occurrence of color unevenness.

In one aspect, the optical conversion layer contains at least a quantum dot A having a light emission center wavelength in a wavelength range of 600 nm to 680 nm, and a quantum dot B having a light emission center wavelength in a wavelength range of 500 nm to 600 nm.

Another aspect of the present invention relates to a liquid crystal display device, comprising: the liquid crystal panel described above; and a backlight unit including a light source.

In one aspect, the light source has a light emission center wavelength in a wavelength range of 430 nm to 480 nm.

Still another aspect of the present invention relates to a polarizing plate, comprising a polarizer; and an optical conversion member including an optical conversion layer containing a quantum dot emitting fluorescent light which is excited by incident excitation light, in which the polarizer and the optical conversion member are integrally laminated.

Further still another aspect of the present invention relates to a polarizing plate protective film, comprising: an optical conversion member including an optical conversion layer containing a quantum dot emitting fluorescent light which is excited by incident excitation light.

According to one aspect of the present invention, it is possible to provide a liquid crystal display device including an optical conversion member containing a quantum dot, in which the occurrence of color unevenness is suppressed.

According to one aspect of the present invention, it is also possible to provide a liquid crystal panel, a polarizing plate, and a polarizing plate protective film, which are able to be used in the liquid crystal display device described above.

### DESCRIPTION OF THE PREFERRED EMBODIMENTS

The following description is based on representative embodiments of the present invention, but the present invention is not limited to such embodiments. Furthermore, in the present invention and herein, a numerical range denoted by using “to” indicates a range including numerical values before and after “to” as the lower limit value and the upper limit value.

In addition, in the present invention and herein, a “half-width” of a peak indicates the width of a peak at a height of ½ of a peak height. In addition, light having a light emission center wavelength in a wavelength range of 400 to 500 nm, and preferably 430 to 480 nm will be referred to as blue light, light having a light emission center wavelength in a wavelength range of 500 to 600 nm will be referred to as green light, and light having a light emission center wavelength in a wavelength range of 600 to 680 nm will be referred to as red light.

In the present invention and herein, the unit of retardation is nm. Re (λ) and Rth (λ) each represent in-plane retardation and retardation in a thickness direction at a wavelength of λ. Re (λ) is measured by allowing light having a wavelength of λ nm to be incident in a film normal direction using KOBRA 21ADH or WR (manufactured by Oji Scientific Instruments). The measurement is able to be performed by manually replacing a wavelength selective filter or by converting a measured value with a program or the like in a case of selecting a measurement wavelength of λ nm. In a case where a film to be measured is denoted by a uniaxial index ellipsoid or a biaxial index ellipsoid, Rth (λ) is calculated by the following method.

In Rth (λ), Re (λ) described above is measured at a total of 6 points by allowing the light having a wavelength of λ nm to be incident from directions respectively tilted in a 10° step from a normal direction to 50° on one side with respect to the film normal direction in which an in-plane slow axis (determined by KOBRA 21ADH or WR) is used as a tilt axis (a rotational axis) (in a case where there is no slow axis, an arbitrary direction of a film plane is used as the rotational axis), and Rth (λ) is calculated by KOBRA 21ADH or WR on the basis of the measured retardation value, an assumed value of the average refractive index, and the input film thickness value. In the above description, in a case of a film having a direction in which a retardation value at a certain tilt angle is zero by using the in-plane slow axis as the rotational axis from the normal direction, a retardation value at a tilt angle greater than the tilt angle described above is changed to have a negative sign, and then, Rth (λ) is calculated by KOBRA 21ADH or WR. Furthermore, a retardation value is measured from two arbitrarily tilt directions by using the slow axis as the tilt axis (the rotational axis) (in a case where there is no slow axis, an arbitrary direction of the film plane is used as the rotational axis), and Rth is able to be calculated by Expression A described below and Expression B described below on the basis of the retardation value, an assumed value of the average refractive index, and the input film thickness value.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Expression ( A )$$

Furthermore, Re (θ) described above indicates a retardation value in a direction tilted by an angle of θ from the normal direction. In addition, in Expression A, nx represents a refractive index in a slow axis direction in the plane, ny represents a refractive index in a direction orthogonal to nx in the plane, and nz represents a refractive index in a direction orthogonal to nx and ny. d represents a film thickness.

Rth=((nx+ny)/2−nz)×d Expression B

In a case where the film to be measured is a so-called film not having an optic axis which is not able to be denoted by a uniaxial index ellipsoid or a biaxial index ellipsoid, Rth (λ) is calculated by the following method. In Rth (λ), Re (λ) described above is measured at 11 points by allowing the light having a wavelength of λ nm to be incident from directions respectively tilted in a 10° step from −50° to +50° with respect to the film normal direction in which the in-plane slow axis (determined by KOBRA 21ADH or WR) is used as the tilt axis (the rotational axis), and Rth (λ) is calculated by KOBRA 21ADH or WR on the basis of the measured retardation value, an assumed value of the average refractive index, and the input film thickness value. In addition, in the measurement described above, a catalog value of various optical films in a polymer handbook (JOHN WILEY & SONS, INC) is able to be used as the assumed value of the average refractive index. In a case where the value of the average refractive index is not known in advance, the value of the average refractive index is able to be measured by using an ABBE'S REFRACTOMETER. The value of the average refractive index of a main optical film will be exemplified as follows: cellulose acylate (1.48), a cycloolefin polymer (1.52), polycarbonate (1.59), polymethyl methacrylate (1.49), and polystyrene (1.59). The assumed values of the average refractive index and the film thickness are input, and thus, nx, ny, and nz are calculated by KOBRA 21ADH or WR. Nz=(nx−nz)/(nx−ny) is further calculated by the calculated nx, ny, and nz.

Furthermore, herein, “visible light” indicates light in a range of 380 to 780 nm. In addition, herein, in a case where a measurement wavelength is not particularly described, the measurement wavelength is 550 nm.

In addition, herein, an angle (for example, an angle of “90°” or the like), and a relationship thereof (for example “orthogonal”, “parallel”, “intersect”, and the like) include an error range which is allowable in the technical field belonging to the present invention. For example, the angle indicates a range of less than an exact angle of ±10°, and an error with respect to the exact angle is preferably in a range of less than or equal to 5°, and is more preferably in a range of less than or equal to 3°.

Herein, a “slow axis” indicates a direction in which a refractive index is maximized. In addition, herein, a “front surface” indicates a normal direction with respect to a display surface.

[Liquid Crystal Panel]

A liquid crystal panel according to one embodiment of the present invention includes a liquid crystal panel member including a visible side polarizer, a liquid crystal cell, and a backlight side polarizer; and an optical conversion member including an optical conversion layer containing a quantum dot emitting fluorescent light which is excited by incident excitation light, and the optical conversion member is integrally laminated on a backlight side surface of the liquid crystal panel member. As described above, by using the liquid crystal panel described above, it is possible to suppress the occurrence of color unevenness in a liquid crystal display device including the optical conversion member.

Hereinafter, the liquid crystal panel described above will be further described in detail.

Optical Conversion Member

The optical conversion member includes at least an optical conversion layer (hereinafter, also referred to as a “quantum dot layer”) containing a quantum dot emitting fluorescent light which is excited by the incident excitation light, and is able to arbitrarily include other layers such as a barrier layer.

(Optical Conversion Layer)

The optical conversion layer contains at least one type of quantum dot, and is able to contain two or more types of quantum dots having different light emission properties. A known quantum dot includes a quantum dot A having a light emission center wavelength in a wavelength range of 600 to 680 nm, a quantum dot B having a light emission center wavelength in a wavelength range of 500 to 600 nm, and a quantum dot C having a light emission center wavelength in a wavelength range of 400 to 500 nm, and the quantum dot A emits red light which is excited by excitation light, the quantum dot B emits green light, and the quantum dot C emits blue light. For example, in a case where the blue light is incident on a optical conversion layer containing the quantum dot A and the quantum dot B as the excitation light, it is possible to embody white light by the red light emitted by the quantum dot A, the green light emitted by the quantum dot B, and the blue light transmitted through the optical conversion layer. Alternatively, ultraviolet light is incident on an optical conversion layer containing the quantum dots A, B, and C as the excitation light, and thus, it is possible to embody white light by the red light emitted by the quantum dot A, the green light emitted by the quantum dot B, and the blue light emitted by the quantum dot C.

In a case where the optical conversion layer contains the quantum dot A emitting the red light and the quantum dot B emitting the green light, and a light source of a backlight unit is a light source emitting blue light (for example, a blue LED), the red light and the green light are obtained by internal light emission in the optical conversion layer, and the blue light exits as light which is transmitted through the optical conversion layer. For this reason, as described above, in a case where the backlight side surface of the liquid crystal panel and the optical conversion member are partially in contact with each other, and thus, a contact portion and a non-contact portion are generated, a change in the extraction efficiency of the red light and the green light between the contact portion and the non-contact portion increases, and a change in the extraction efficiency of the blue light between the contact portion and the non-contact portion decreases. The detailed description of this point is as follows. In the non-contact portion, an air layer exists between the liquid crystal panel and the optical conversion member. The red light and the green light are isotropically emitted by the optical conversion layer, and the total reflection occurs on the boundary surface of the air layer according to a refractive index difference on the boundary surface. In the contact portion, the air layer does not exist, and thus, the refractive index difference on the boundary surface decreases, and the incidence light amount (extraction efficiency) with respect to the liquid crystal panel increases. On the other hand, the blue light is emitted by the light source of the backlight unit and is transmitted through the optical conversion layer, and thus, an incidence angle with respect to the boundary surface between the optical conversion layer and the air layer in the non-contact portion decreases, and the total reflection rarely occurs. Therefore, a change in the extraction efficiency between the contact portion and the non-contact portion decreases. As described above, a change in the light amount of the red light and the green light is larger than that of the blue light, and thus, color unevenness is visible in a liquid crystal display device.

As described above, the occurrence of such color unevenness is able to be suppressed by integrally laminating the optical conversion member on the backlight side surface of the liquid crystal panel member.

The optical conversion layer of the optical conversion member is able to contain a quantum dot in an organic matrix. In general, the organic matrix is a polymer which is polymerized by performing light irradiation or the like with respect to a polymerizable composition. The shape of the optical conversion layer is not particularly limited, and the optical conversion layer is able to have an arbitrary shape such as a sheet-like shape and a bar-like shape. The quantum dot, for example, can be referred to paragraphs 0060 to 0066 of JP2012-169271A, but is not limited thereto. A commercially available product is able to be used as the quantum dot without any limitation. In general, the light emission wavelength of the quantum dot is able to be adjusted according to the composition of the particles, the size of the particles, and the composition and the size.

It is preferable that the optical conversion layer is prepared by a coating method. Specifically, a polymerizable composition (a curable composition) containing a quantum dot is applied onto a substrate or the like, such as glass, and then, a curing treatment is performed by light irradiation or the like, and thus, an optical conversion layer is able to be obtained.

A polymerizable compound which is used for preparing the polymerizable composition is not particularly limited. A (meth)acrylate compound such as a monofunctional or polyfunctional (meth)acrylate monomer, a polymer thereof, a prepolymer thereof, and the like are preferable from the viewpoint of the transparency, the adhesiveness, or the like of a cured film after being cured. Furthermore, in the present invention and herein, the “(meth)acrylate” is used as the meaning including at least one of acrylate or methacrylate, or any one of acrylate and methacrylate. The same applies to “(meth)acryloyl” or the like.

Examples of the monofunctional (meth)acrylate monomer are able to include an acrylic acid and a methacrylic acid, and a derivative thereof, and more specifically, a monomer having one polymerizable unsaturated bond of a (meth)acrylic acid (one (meth)acryloyl group) in the molecule. Specific examples thereof can be referred to paragraph 0022 of WO2012/077807A1.

A polyfunctional (meth)acrylate monomer having two or more (meth)acryloyl groups in the molecules is able to be used along with a monomer having one polymerizable unsaturated bond of the (meth)acrylic acid (one (meth)acryloyl group) in one molecule. The details thereof can be referred to paragraph 0024 of WO2012/077807A1. In addition, a polyfunctional (meth)acrylate compound disclosed in paragraphs 0023 to 0036 of JP2013-043382A is able to be used as the polyfunctional (meth)acrylate compound. Further, an alkyl chain-containing (meth)acrylate monomer denoted by General Formulas (4) to (6) disclosed in paragraphs 0014 to 0017 of the specification of JP5129458B is also able to be used.

The use amount of the polyfunctional (meth)acrylate monomer is preferably greater than or equal to 5 parts by mass, from the viewpoint of strength of a coating film, and is preferably less than or equal to 95 parts by mass from the viewpoint of suppressing gelation of the composition, with respect to 100 parts by mass of the total amount of the polymerizable compound contained in the polymerizable composition. In addition, from the same viewpoint, it is preferable that the use amount of the monofunctional (meth)acrylate monomer is greater than or equal to 5 parts by mass and less than or equal to 95 parts by mass, with respect to 100 parts by mass of the total amount of the polymerizable compound contained in the polymerizable composition. In addition, it is preferable that the content of the total polymerizable compound is approximately 10 to 99.99 mass % with respect to the total amount of the polymerizable composition.

The polymerizable composition described above is able to contain a known radical initiator as a polymerization initiator. The polymerization initiator, for example, can be referred to paragraph 0037 of JP2013-043382A. The amount of polymerization initiator is preferably greater than or equal to 0.1 mol %, and is more preferably 0.5 to 2 mol %, with respect to the total amount of the polymerizable compound contained in the polymerizable composition.

The quantum dot may be added to the polymerizable composition in a state of particles, or may be added to the polymerizable composition in a state of a dispersion in which the quantum dot is dispersed in a solvent. Adding the quantum dot in a state of the dispersion is preferable from the viewpoint of suppressing the aggregation of the particles of the quantum dot. Here, a solvent to be used is not particularly limited. The added amount of the quantum dot, for example, is able to be approximately 0.1 to 10 parts by mass, with respect to 100 parts by mass of the total amount of the composition.

The polymerizable composition containing a quantum dot described above is applied onto a suitable support and is dried, and a solvent is removed, and then, the polymerizable composition is polymerized and cured by light irradiation or the like, and thus, a quantum dot layer is able to be obtained. Examples of a coating method include a known coating method such as a curtain coating method, a dip coating method, a spin coating method, a printing coating method, a spray coating method, a slot coating method, a roll coating method, a slide coating method, a blade coating method, a gravure coating method, and a wire bar method. In addition, curing conditions are able to be suitably set according to the type of polymerizable compound to be used or the composition of the polymerizable composition.

The total thickness of the optical conversion layer is preferably less than or equal to 500 μm from the viewpoint of obtaining sufficient excitation light transmittance, and is preferably greater than or equal to 1 μm from the viewpoint of obtaining sufficient fluorescent light. It is more preferable that the total thickness of the optical conversion layer is in a range of 100 to 400 μm. In addition, the optical conversion layer may have a laminated structure of two or more layers, or may have a quantum dot layer containing two or more quantum dots having different light emission properties in the same layer. In a case where the optical conversion layer includes a plurality of quantum dot layers, the film thickness of one layer is preferably in a range of 1 to 300 μm, and is more preferably in a range of 10 to 250 μm.

(Barrier Layer)

The optical conversion member is able to include one or more barrier layers as a layer which is directly in contact with one surface or both surfaces of the optical conversion layer, or through an interlayer such as an adhesive layer.

By disposing the barrier layer, it is possible to prevent the deterioration of the quantum dot which is contained in the optical conversion layer due to oxygen, moisture of water vapor, or the like. The oxygen permeability of the barrier layer is preferably less than 1.0 cm³/(m²·day), is more preferably less than or equal to 0.5 cm³/(m²·day), is even more preferably less than or equal to 0.1 cm³/(m²·day), and still more preferably less than or equal to 0.05 cm³/m²·day, from the viewpoint of protecting the quantum dot.

On the other hand, from the same viewpoint, the water vapor permeability of the barrier layer is preferably less than or equal to 0.5 g/(m²·day), is more preferably less than or equal to 0.1 g/(m²·day), and is particularly preferably less than or equal to 0.05 g/(m²·day).

In addition, disposing the barrier layer, and integrally laminating the barrier layer on the liquid crystal panel member are effective for preventing the occurrence of brightness unevenness described above.

Here, the oxygen permeability described above is a value measured by using an oxygen gas permeability measurement device (OX-TRAN 2/20: Product Name, manufactured by MOCON Inc.) under conditions of a measurement temperature of 23° C. and relative humidity of 90%, and the water vapor permeability described above is a value measured by using a water vapor permeability measurement device (PERMATRAN-W 3/31: Product Name, manufactured by MOCON Inc.) under conditions of a measurement temperature of 37.8° C. and relative humidity of 100%.

The barrier layer may be an organic or inorganic single layer, or may have a laminated structure of two or more layers. For example, the barrier layer is able to be obtained by forming two or more organic or inorganic layers on the substrate. Examples of the layer configuration of the barrier layer are able to include a configuration in which the substrate/the inorganic layer/the organic layer are laminated in this order from the optical conversion layer side towards the outside, a configuration in which the substrate/the inorganic layer/the organic layer/the inorganic layer are laminated in this order, and the like, but the lamination order is not particularly limited.

A transparency substrate which is transparent with respect to visible light is preferable as the substrate. Here, being transparent with respect to the visible light indicates that light ray transmittance in a visible light range is greater than or equal to 80%, and is preferably greater than or equal to 85%. The light ray transmittance which is used as the scale of transparency is able to be calculated by a method disclosed in JIS-K7105, that is, by measuring the total light ray transmittance and the scattered light amount using an integrating sphere type light ray transmittance measurement device, and by subtracting diffusion transmittance from the total light ray transmittance. The substrate can be referred to paragraphs 0046 to 0052 of JP2007-290369A and paragraphs 0040 to 0055 of JP2005-096108A. The thickness of the substrate is preferably in a range of 10 μm to 500 μm, is more preferably in a range of 10 to 200 μm, and is particularly preferably in a range of 20 to 100 μm, impact resistance, from the viewpoint of handling or the like in the manufacturing of the barrier film.

The inorganic layer can be referred to paragraphs 0043 to 0045 of JP2007-290369A and paragraphs 0064 to 0068 of JP2005-096108A. The film thickness of the inorganic layer is preferably in a range of 10 nm to 500 nm, is more preferably in a range of 10 nm to 300 nm, and is particularly preferably in a range of 10 nm to 150 nm. By setting the film thickness of the inorganic layer to be in the range described above, it is possible to suppress reflection on the barrier film while realizing excellent gas barrier properties, and it is possible to suppress a decrease in the total light ray transmittance. In particular, it is preferable that the inorganic layer is a silicon oxide film, a silicon oxynitride film, or a silicon oxynitride film. Such a film has excellent adhesiveness with respect to the organic film, and thus, it is possible to realize more excellent gas barrier properties.

The organic layer can be referred to paragraphs 0020 to 0042 of JP2007-290369A and paragraphs 0074 to 0105 of JP2005-096108A. Furthermore, it is preferable that the organic layer contains a CARDO polymer. Accordingly, the adhesiveness with respect to a layer adjacent to the organic layer or the substrate, and in particular, the adhesiveness with respect to the inorganic layer becomes excellent, and thus, more excellent gas barrier properties are able to be realized. The details of the CARDO polymer can be referred to paragraphs 0085 to 0095 of JP2005-096108A described above. The film thickness of the organic layer is preferably in a range of 0.05 μm to 10 μm, and is more preferably in a range of 0.5 to 10 μm. In a case where the organic layer is formed by a wet coating method, the film thickness of the organic layer is preferably in a range of 0.5 μm to 10 μm, and is more preferably in a range of 1 μm to 5 μm. In addition, in a case where the organic layer is formed by a dry coating method, the film thickness of the organic layer is preferably in a range of 0.05 μm to 5 μm, and is more preferably in a range of 0.05 μm to 1 μm. By setting the film thickness of the organic layer which is formed by the wet coating method or the dry coating method to be in the range described above, it is possible to make the adhesiveness with respect to the inorganic layer more excellent.

The other details of the barrier layer can be referred to the description of JP2007-290369A, JP2005-096108A, and US2012/0113672A1 described above.

(Easily Adhesive Layer)

In the liquid crystal panel according to one embodiment of the present invention, the optical conversion member is integrally laminated on the liquid crystal panel member. In order to improve the adhesiveness between the optical conversion member and the liquid crystal panel member, it is preferable that an easily adhesive layer is disposed on the optical conversion member. The easily adhesive layer may be one layer, or two or more easily adhesive layers may be laminated. A known easily adhesive layer is able to be used as the easily adhesive layer without any limitation use. In addition, one embodiment of a preferred easily adhesive layer will be described below.

In general, the easily adhesive layer is formed by applying a coating liquid formed of a binder, a curing agent, and a surfactant. In addition, the easily adhesive layer may suitably contain organic or inorganic fine particles.

The binder which is used in the easily adhesive layer is not particularly limited, but polyester, polyurethane, an acrylic resin, a styrene butadiene copolymer, a polyolefin resin, and the like are preferable from the viewpoint of an adhesive force. In addition, it is particularly preferable that the binder has water solubility or water dispersibility from the viewpoint of reducing a load on the environment.

The easily adhesive layer is able to contain metal oxide particles which exhibit conductivity by electron conduction. A general metal oxide is able to be used as the metal oxide particles, and examples of the metal oxide include ZnO, TiO₂, SnO₂, Al₂O₃, In₂O₃, MgO, BaO, MoO₃, a composite oxide thereof, a metal oxide in which a small amount of different elements is further contained in the metal oxide, and the like. Among such metal oxides, SnO₂, ZnO, TiO₂, and In₂O₃ are preferable, and SnO₂ is particularly preferable. A it electron conjugated conductive polymer such as a polythiophene-based conductive polymer may be contained instead of the metal oxide particles which exhibit conductivity by the electron conduction.

Either the metal oxide particles which exhibit conductivity by the electron conduction or the r electron conjugated conductive polymer is added to the easily adhesive layer, and thus, it is possible to adjust the surface electrical resistance of the easily adhesive layer to be less than or equal to 10¹²Ω/square. Accordingly, the optical conversion member is able to obtain sufficient antistatic properties, and thus, is able to prevent mote or dust from being adsorbed.

In order to adjust the refractive index of the easily adhesive layer, fine particles of a metal oxide may be contained in the easily adhesive layer. Tin oxide, zirconium oxide, zinc oxide, titanium oxide, cerium oxide, niobium oxide, and the like, which have a high refractive index, are preferable as the metal oxide. The refractive index is able to be changed as the refractive index becomes higher even in a case of a small amount of metal oxide is contained. The particle diameter of the fine particles of the metal oxide is preferably in a range of 1 nm to 50 nm, and is more preferably in a range of 2 nm to 40 nm. The amount of the fine particles of the metal oxide may be determined according to a target refractive index, and it is preferable that the fine particles of the metal oxide are contained in the easily adhesive layer such that the amount of the fine particles is in a range of 10 to 90%, and it is more preferable that the fine particles of the metal oxide are contained in the easily adhesive layer such that the amount of the fine particles is in a range of 30 to 80%, on a mass basis at the time of setting the mass of the easily adhesive layer to 100%.

The thickness of the easily adhesive layer is able to be controlled by adjusting the coating amount of the coating liquid forming the easily adhesive layer. In order to exhibit high transparency and an excellent adhesive force, it is preferable that the thickness is in a range of 0.01 to 5 μm. By setting the thickness to be greater than or equal to 0.01 μm, it is possible to more reliably improve the adhesive force, compared to a case where the thickness is less than 0.01 μm. By setting the thickness to be less than or equal to 5 μm, it is possible to form an easily adhesive layer having a more uniform thickness, compared to a case where the thickness is greater than 5 μm. Further, an increase in the use amount of the coating liquid is able to be suppressed, an increase in a drying time is able to be prevented, and an increase in costs is able to be suppressed. A more preferred range of the thickness of the easily adhesive layer is 0.02 μm to 3 μm. In addition, two or more easily adhesive layers may be laminated in the thickness range described above.

The easily adhesive layer described above may be disposed on the liquid crystal panel member described below and a brightness enhancement film described below.

Liquid Crystal Panel Member

The liquid crystal panel member includes the visible side polarizer, the liquid crystal cell, and the backlight side polarizer, and is able to arbitrarily include various layers such as a protective film and a retardation plate, which are generally included in the liquid crystal panel.

(Liquid Crystal Cell)

The driving mode of the liquid crystal cell is not particularly limited, and various modes such as a twisted nematic (TN) mode, a super twisted nematic (STN) mode, a vertical alignment (VA) mode, an in-plane switching (IPS) mode, and an optically compensated bend cell (OCB) mode are able to be used.

In general, the liquid crystal cell includes two substrates, and a liquid crystal layer positioned between the two substrates. In general, the substrate is a glass substrate, or may be a plastic substrate or a laminate of a glass substrate and a plastic substrate. In a case where the plastic substrate is independently used as the substrate, a material such as polycarbonate (PC) and polyether sulfone (PES), which rarely has in-plane optical anisotropy, is useful since such a material does not inhibit polarization control of the liquid crystal layer. In general, the thickness of one substrate is in a range of 50 μm to 2 mm, and the liquid crystal panel is easily warped due to the deformation of the polarizing plate and the color unevenness described above easily occurs as the substrate becomes thinner. In contrast, in one embodiment of the present invention, the optical conversion member is integrally laminated on the backlight side surface of the liquid crystal panel, and thus, the occurrence of color unevenness is able to be suppressed. Therefore, one embodiment of the present invention is particularly effective in an embodiment including a liquid crystal cell in which the thickness of one substrate is thin (the thickness is not particularly limited, and for example, is less than or equal to 0.3 mm).

In general, the liquid crystal layer of the liquid crystal cell is formed by sealing a space which is formed by interposing a spacer between the two substrates with a liquid crystal. In general, a transparent electrode layer is formed on the substrate as a transparent film containing a conductive substance. Further, layers such as a gas barrier layer, a hard coat layer, and an undercoat layer which is used for adhesion of the transparent electrode layer may be disposed on the liquid crystal cell. In general, such layers are disposed on the substrate.

(Polarizer)

In the liquid crystal panel member, the polarizers arranged by interposing the liquid crystal cell therebetween (the visible side polarizer and the backlight side polarizer) are a polarizer for turning on or off light which is transmitted through the liquid crystal cell, and are a polarizer (a so-called absorptive polarizer) having properties of absorbing light which is not transmitted. In the following description, the polarizer indicates an absorptive polarizer unless otherwise particularly stated. In response, the reflection polarizer of which the details will be described below has a function of reflecting light in a first polarization state and transmitting light in a second polarization state among incidence light rays.

The visible side polarizer and the backlight side polarizer are not particularly limited insofar as the visible side polarizer and the backlight side polarizer have properties as the absorptive polarizer, and a polarizer which is generally used in a liquid crystal display device is able to be used without any limitation. For example, a stretched film or the like, in which a polyvinyl alcohol film is dipped in an iodine solution and is stretched, is able to be used. The thickness of the polarizer is not particularly limited. It is preferable that the thickness of the polarizer is thin from the viewpoint of thinning the liquid crystal display device, and it is preferable that the polarizer has a uniform thickness in order to maintain the contrast of the polarizing plate. From the viewpoint described above, the thicknesses of the visible side polarizer and the backlight side polarizer are preferably in a range of 0.5 μm to 80 μm, are more preferably in a range of 0.5 μm to 50 μm, and are even more preferably in a range of 1 μm to 25 μm. In addition, the thicknesses of the visible side polarizer and the backlight side polarizer may be identical to each other or different from each other. It is preferable that the thicknesses of the visible side polarizer and the backlight side polarizer are different from each other from the viewpoint of suppressing the warping of the liquid crystal panel. The details of the polarizer can be referred to paragraphs 0037 to 0046 of JP2012-189818A.

(Protective Film)

In general, the polarizing plate includes a protective film on one surface or both surfaces of the polarizer. In the liquid crystal panel according to one embodiment of the present invention, each of the visible side polarizer and the backlight side polarizer may include the protective film on one surface or both surfaces. The thickness of the protective film is able to be suitably set, and in general, the thickness of the protective film is approximately 1 to 500 μm, is preferably 1 to 300 μm, is more preferably 5 to 200 μm, and is even more preferably 5 to 150 μm, from the viewpoint of workability such as strength or handling, a reduction in layer thickness, or the like. Furthermore, the visible side polarizer and the backlight side polarizer may be bonded to the liquid crystal cell without using the protective film. This is because, in particular, the substrate of the liquid crystal cell is able to exhibit a barrier function.

A thermoplastic resin having excellent transparency, mechanical strength, heat stability, moisture blocking properties, isotropy, and the like is preferably used as the protective film of the polarizing plate. Specific examples of such a thermoplastic resin include a cellulose resin such as triacetyl cellulose, a polyester resin, a polyether sulfone resin, a polysulfone resin, a polycarbonate resin, a polyamide resin, a polyimide resin, a polyolefin resin, a (meth)acrylic resin, a cyclic polyolefin resin (a norbornene-based resin), a polyarylate resin, a polystyrene resin, a polyvinyl alcohol resin, and a mixture thereof. The details of the resins which are able to be used as the protective film can be referred to paragraphs 0049 to 0054 of JP2012-189818A.

A polarizing plate protective film including one or more functional layers on a thermoplastic resin film is able to be used as the polarizing plate protective film. Examples of the functional layer include a layer of low moisture permeability, a hard coat layer, an anti-reflection layer (a layer in which a refractive index is adjusted, such as a layer of low refractive index, a layer of intermediate refractive index, and a layer of high refractive index), an antiglare layer, an antistatic layer, an ultraviolet absorbing layer, and the like. For example, using a protective film including a layer of low moisture permeability as the polarizing plate protective film is effective from the viewpoint of suppressing the deformation of the polarizer due to a humidity change. A known technology is able to be applied to such a functional layer without any limitation. The thickness of the protective film including the functional layer, for example, is in a range of 5 to 100 μm, is preferably in a range of 10 to 80 μm, and is more preferably in a range of 15 to 75 nm. Furthermore, only the functional layer is able to be laminated on the polarizer without using the thermoplastic resin film.

(Adhesive Layer and Pressure Sensitive Adhesive Layer)

The polarizer and the protective film are able to be bonded to each other by a known adhesive layer or a known pressure sensitive adhesive layer. The details, for example, can be referred to paragraphs 0056 to 0058 of JP2012-189818A and paragraphs 0061 to 0063 of JP2012-133296A. In addition, in the liquid crystal panel, the liquid crystal display device, the polarizing plate, and the polarizing plate protective film according to one embodiment of the present invention, in a case where the layers and the members are bonded to each other, the known adhesive or the known pressure sensitive adhesive layer is able to be used.

(Retardation Layer)

The visible side polarizing plate and the backlight side polarizing plate are able to include at least one retardation layer between the liquid crystal cell, and the visible side polarizing plate and the backlight side polarizing plate. For example, the retardation layer may be included as an inner side polarizing plate protective film on the liquid crystal cell side. A known cellulose acylate film or the like is able to be used as such a retardation layer.

Bonding of Optical Conversion Member and Liquid Crystal Panel Member

In the liquid crystal panel according to one embodiment of the present invention, the optical conversion member is integrally laminated on the backlight side surface of the liquid crystal panel member. Bonding for integrally laminating the optical conversion member on the backlight side surface of the liquid crystal panel member is able to be performed through an adhesive layer or a pressure sensitive adhesive layer. The details are identical to the description with respect to the adhesive layer and the pressure sensitive adhesive layer described above. In addition, as described above, it is possible to bond the liquid crystal panel member to the optical conversion member the lamination processing using an adhesive the lamination processing not using an adhesive (thermal pressure bonding). Alternatively, as described above, it is possible to form the optical conversion member on the backlight side surface of the liquid crystal panel member by coating.

Brightness Enhancement Film

The liquid crystal panel according to one embodiment of the present invention is able to include a brightness enhancement film. Recently, in order to increase light utilization efficiency according to the power saving of the backlight, the brightness enhancement film is a functional film which is mainly arranged between the backlight and the backlight side polarizing plate of the liquid crystal cell. The brightness enhancement film is a functional film which is able to have a function of increasing the brightness of the display surface of the liquid crystal display device, compared to a case of not including such a film.

In one embodiment, the backlight side polarizer, the brightness enhancement film, and the optical conversion layer are arranged in the liquid crystal panel in this order. The brightness enhancement film is able to be bonded by using a known adhesive or a known pressure sensitive adhesive.

One embodiment of the brightness enhancement film is an embodiment including a reflection polarizer (hereinafter, referred to as an “embodiment 1”), and the other embodiment is an embodiment including an optically functional layer performing light condensation or diffusion by refracting incidence light (hereinafter, referred to as an “embodiment II”).

Hereinafter, each embodiment will be sequentially described.

The reflection polarizer has a function of reflecting light in a first polarization state and of transmitting light in a second polarization state among incidence light rays. The light in the first polarization state which is reflected on the reflection polarizer is recirculated by randomizing the direction and the polarization state using a reflection member included in the backlight unit (also referred to as a light guide device or an optical resonator). Accordingly, brightness of a display surface of the liquid crystal display device is able to be improved. Any one of a reflection polarizer which allows circularly polarized light to exit and a reflection polarizer which allows linearly polarized light to exit may be used as the reflection polarizer. A brightness enhancement film including a reflection polarizer allowing circularly polarized light to exit is able to further include a λ/4 plate. The light in the second polarization state which is transmitted through the reflection polarizer (for example, left circularly polarized light) is able to be converted into linearly polarized light by the λ/4 plate, and is able to be transmitted through the backlight side polarizer (linear polarizer). The λ/4 plate may be a single layer, or a laminate of two or more layers, and the laminate of two or more layers is preferable.

A preferred embodiment of the reflection polarizer allowing circularly polarized light to exit is a cholesteric liquid crystal layer, and is more preferably a reflection polarizer including a first light reflection layer which has a reflection center wavelength in a wavelength range of 430 to 480 nm, has a reflectivity peak having a half-width of less than or equal to 100 nm, and is formed by immobilizing a cholesteric liquid crystalline phase allowing circularly polarized light to exit, a second light reflection layer which has a reflection center wavelength in a wavelength range of 500 to 600 nm, has a reflectivity peak having a half-width of less than or equal to 100 nm, and is formed by immobilizing a cholesteric liquid crystalline phase allowing circularly polarized light to exit, and a third light reflection layer which has a reflection center wavelength in a wavelength range of 600 to 650 nm, has a reflectivity peak having a half-width of less than or equal to 100 nm, and is formed by immobilizing a cholesteric liquid crystalline phase allowing circularly polarized light to exit.

A brightness enhancement layer of the related art provides a broadband optical recycling function with respect to white light, and thus, manufacturing costs increase on complicated design in consideration of a multi-layer configuration and wavelength dispersibility of a member. In contrast, the liquid crystal panel according to one embodiment of the present invention contains a quantum dot in the optical conversion member, and thus, it is possible to obtain bright line light of RGB (preferably having a half-width of less than or equal to 100 nm) of which the light emission peak of an RGB wavelength range is narrow. Therefore, a light utilization rate increases by using the reflection polarizer having a narrow reflection peak in the RGB wavelength range described above, and thus, it is possible to improve front brightness, front contrast, and a color reproduction range by a simple configuration. It is preferable that the reflection polarizer described above includes only the first light reflection layer, the second light reflection layer, and the third light reflection layer as the cholesteric liquid crystal layer from the viewpoint of decreasing the film thickness of the brightness enhancement film, that is, it is preferable that the reflection polarizer does not include other cholesteric liquid crystal layers.

Hereinafter, the light reflection layer described above will be described.

The first light reflection layer has a reflection center wavelength in a wavelength range of 430 to 480 nm and a reflectivity peak having a half-width of less than or equal to 100 nm.

It is preferable that the reflection center wavelength of the first light reflection layer is in a wavelength range of 430 to 470 nm.

The half-width of the reflectivity peak of the first light reflection layer is preferably less than or equal to 100 nm, is more preferably less than or equal to 80 nm, and is particularly preferably less than or equal to 70 nm.

The second light reflection layer has a reflection center wavelength in a wavelength range of 500 to 600 nm and a reflectivity peak having a half-width of less than or equal to 100 nm.

It is preferable that the reflection center wavelength of the second light reflection layer is in a wavelength range of 520 to 560 nm.

The half-width of the reflectivity peak of the second light reflection layer is preferably less than or equal to 100 nm, is more preferably less than or equal to 80 nm, and is particularly preferably less than or equal to 70 nm.

The third light reflection layer has a reflection center wavelength in a wavelength range of 600 to 650 nm and a reflectivity peak having a half-width of less than or equal to 100 nm.

It is preferable that the reflection center wavelength of the third light reflection layer is in a wavelength range of 610 to 640 nm.

The half-width of the reflectivity peak of the third light reflection layer is preferably less than or equal to 100 nm, is more preferably less than or equal to 80 nm, and is particularly preferably less than or equal to 70 nm.

A wavelength providing a peak (that is, a reflection center wavelength) is able to be adjusted by changing the pitch or the refractive index of the cholesteric liquid crystal layer, and changing the pitch is able to easily adjust the wavelength by changing the added amount of a chiral agent. Specifically, the details are disclosed in Fuji Film Research & Development No. 50 (2005) pp. 60 to 63.

The lamination order of the first light reflection layer, the second light reflection layer, and third light reflection layer will be described. Front brightness is able to be improved in any lamination order. However, coloration occurs due to the influence of the first light reflection layer, the second light reflection layer, and the third light reflection layer in a tilt azimuth. This is due to the following two reasons. One reason is that the reflectivity peak wavelength of the light reflection layer is shifted to a short wave side with respect to the peak wavelength of the front surface in the tilt azimuth. For example, in the light reflection layer having a reflection center wavelength in a wavelength range of 500 to 600 nm, the center wavelength is shifted to a wavelength range of 400 to 500 nm in the tilt azimuth. The other reason is that the light reflection layer functions as a negative C plate (a retardation plate having positive Rth) in a wavelength range where the light reflection layer does not reflect light, and thus, the coloration occurs due to the influence of retardation in the tilt azimuth.

The present inventors have specifically conducted studies with respect to the reasons for the coloration, and thus, have found that there is an arrangement order which is most preferable for suppressing the coloration according to the lamination order of the first light reflection layer, the second light reflection layer, and the third light reflection layer. That is, it is most preferable that the first light reflection layer having the smallest wavelength is positioned on the light source side (a blue layer: B), and then, the third light reflection layer having the largest wavelength is positioned (a red layer: R), and then, the second light reflection layer having the intermediate wavelength (a green layer: G) is positioned as seen from the backlight unit (the light source) side. That is, an order of BRG (the first light reflection layer, the third light reflection layer, and the second light reflection layer) is obtained from the backlight unit (the light source) side.

The lamination order of the first light reflection layer, the second light reflection layer, and the third light reflection layer is any one of arrangement orders such as an order of BRG (the first light reflection layer, the third light reflection layer, and the second light reflection layer), an order of BGR (the first light reflection layer, the second light reflection layer, and the third light reflection layer), an order of GBR (the second light reflection layer, the first light reflection layer, and the third light reflection layer), an order of GRB (the second light reflection layer, the third light reflection layer, and the first light reflection layer), an order of RBG (the third light reflection layer, the first light reflection layer, and the second light reflection layer), or an order of RGB (the third light reflection layer, the second light reflection layer, and the first light reflection layer) from the backlight unit side;

the arrangement order such as the order of BRG (the first light reflection layer, the third light reflection layer, and the second light reflection layer), the order of BGR (the first light reflection layer, the second light reflection layer, and the third light reflection layer), or the order of GBR (the second light reflection layer, the first light reflection layer, and the third light reflection layer) from the backlight unit side is preferable; and

the arrangement order such as the order of BRG (the first light reflection layer, the third light reflection layer, and the second light reflection layer) from the backlight unit side is more preferable.

A manufacturing method of the light reflection layer formed by immobilizing the cholesteric liquid crystalline phase described above is not particularly limited, and for example, methods disclosed in JP1989-133003A (JP-H01-133003A), JP3416302B, JP3363565B, and JP1996-271731A (JP-H08-271731 A) are able to be used, and the contents of the publications are incorporated in the present invention. More specifically, the manufacturing method can be referred to paragraphs 0011 to 0015 of JP 1996-271731A (JP-H08-271731A).

(λ/4 Plate)

The λ/4 plate is a layer for converting circularly polarized light which exits from the reflection polarizer to linearly polarized light. Simultaneously, the retardation (Rth) in the thickness direction is adjusted, and thus, positive retardation in the thickness direction which occurs in a case of being seen from the tilt azimuth is able to be cancelled.

Accordingly, it is preferable that the retardation (Rth) of the λ/4 plate in the thickness direction is a value close to 0, and it is more preferable that the retardation (Rth) of the λ/4 plate in the thickness direction is a negative value. A preferred Rth value is different depending on the order of the light reflection layers. As described above, this is because the light reflection layer functions as a negative C plate, that is, a retardation plate having positive Rth in a wavelength range where the light reflection layer does not reflect light, and thus, the order of the light reflection layers directly affects a wavelength which provides preferred retardation.

A manufacturing method of the λ/4 plate is not particularly limited. Examples of a ¼ wavelength plate formed of a superposed body of the retardation film include a ¼ wavelength plate in which a plurality of retardation films of a combination of a retardation film providing retardation of a ½ wavelength with respect to monochromatic light and a retardation film providing retardation of a ¼ wavelength with respect to monochromatic light are laminated such that optical axes thereof intersect with each other. By laminating a plurality of retardation films providing retardation of a ½ wavelength or a ¼ wavelength with respect to monochromatic light such that the optical axes intersect with each other, wavelength dispersion of the retardation defined as a product (Δnd) of a refractive index difference (Δn) of birefringent light and a thickness (d) is able to be superposed or modulated, and is able to be arbitrarily controlled, the wavelength dispersion is suppressed while controlling the entire retardation to be in a ¼ wavelength, and thus, it is possible to obtain a wavelength plate providing retardation of a ¼ wavelength over a wide wavelength range. For example, a method disclosed in JP1996-271731A (JP-H08-271731A) is able to be used as the manufacturing method of the λ/4 plate, and the contents of the publication are incorporated in the present invention. More specifically, the manufacturing method can be referred to paragraphs 0016 to 0024 of JP1996-271731A (JP-H08-271731A).

Alternatively, a λ/4 plate which is prepared as a laminate of the optically anisotropic layer used as the λ/2 plate and the λ/4 plate described below is able to be used as the λ/4 plate.

The optically anisotropic layer is able to be formed of one type or a plurality of types of curable compositions containing a liquid crystal compound as a main component. It is preferable that the liquid crystal compound is a liquid crystal compound having a polymerizable group. λ/4 plate (an optically anisotropic layer) which is used in the λ/4 plate for converting circularly polarized light exiting from the reflection polarizer into linearly polarized light may be an optically anisotropic support having a desired a λ/4 function in a support itself, or may include an optically anisotropic layer or the like on a support formed of a polymer film. In the latter case, other layers are laminated on the support, and thus, a desired λ/4 function is obtained. The configuration material of the optically anisotropic layer is not particularly limited. The optically anisotropic layer may be a layer which is formed of a composition containing a liquid crystal compound and has optical anisotropy exhibited by aligning molecules of the liquid crystal compound or a layer which has optical anisotropy exhibited by stretching a polymer film and by aligning the polymer in the film, or may be both of the layers. That is, the optically anisotropic layer is able to be configured of one or two or more biaxial films, and is also able to be configured of a combination of two or more monoaxial films such as a combination of a C plate and an A plate. The optically anisotropic layer is able to be configured of a combination of one or more biaxial films and one or more monoaxial films.

Here, the “λ/4 plate” which is used in the λ/4 plate for converting circularly polarized light exiting from the reflection polarizer into linearly polarized light indicates an optically anisotropic layer in which in-plane retardation Re (λ) at a specific wavelength of λ nm satisfies Re (λ)=λ/4. The expression described above may be attained at any wavelength (for example, 550 nm) in a visible light range, and in-plane retardation Re (550) at a wavelength of 550 nm is preferably 115 nm≦Re (550)≦155 nm, and is more preferably in a range of 120 nm to 145 nm. It is preferable that the in-plane retardation Re (550) at a wavelength of 550 nm is in this range since the light leakage of reflected light is able to be reduced to the extent of being invisible at the time of being combined with the λ/2 plate described below.

A λ/2 plate which is used in the λ/4 plate for converting circularly polarized light exiting from the reflection polarizer into linearly polarized light may be an optically anisotropic support having a desired λ/2 function in a support itself, or may include an optically anisotropic layer or the like on a support formed of a polymer film. In the latter case, other layers are laminated on the support, and thus, a desired λ/2 function is obtained. The configuration material of the optically anisotropic layer is not particularly limited. The optically anisotropic layer may be a layer which is formed of a composition containing a liquid crystal compound and has optical anisotropy exhibited by aligning molecules of the liquid crystal compound or a layer which has optical anisotropy exhibited by stretching a polymer film and by aligning the polymer in the film, or may be both of the layers. That is, the optically anisotropic layer is able to be configured of one or two or more biaxial films, and is also able to be configured of a combination of two or more monoaxial films such as a combination of a C plate and an A plate. The optically anisotropic layer is able to be configured of a combination of one or more biaxial films and one or more monoaxial films.

Here, the “λ/2 plate” which is used in the λ/4 plate for converting circularly polarized light exiting from the reflection polarizer into linearly polarized light indicates an optically anisotropic layer in which in-plane retardation Re (λ) at a specific wavelength of λ nm satisfies Re (λ)=λ/2. The expression described above may be attained at any wavelength (for example, 550 nm) in a visible light range. Further, it is preferable that in-plane retardation Re1 of the λ/2 plate is set to be substantially two times in-plane retardation Re2 of the λ/4 plate.

Here, the “retardation is substantially two times” indicates that Re1=2×Re2±50 nm.

Re1=2×Re2±20 nm is more preferable, and Re1=2×Re2±10 nm is even more preferable. The expression described above may be attained at any one wavelength in a visible light range, and it is preferable that the expression described above is attained at a wavelength of 550 nm. It is preferable that the in-plane retardation Re (550) at a wavelength of 550 nm is in this range since the light leakage of the reflected light is able to be reduced to the extent of being invisible at the time of being combined with the A λ/4 plate described below.

The direction of the linearly polarized light which exits from the reflection polarizer and is transmitted through the λ/4 plate is laminated to be parallel to a transmission axis direction of the backlight side polarizing plate.

In a case where the λ/4 plate is a single layer, an angle between a slow axis direction of the λ/4 plate and an absorption axis direction of the polarizing plate is 45°.

In a case where the λ/4 plate is a laminate of a λ/4 plate and a λ/2 plate, the angles between the slow axis directions of each of the λ/4 plate and the λ/2 plate and the absorption axis direction of the polarizing plate have the following positional relationship.

In a case where Rth of the λ/2 plate at a wavelength of 550 nm is negative, an angle between the slow axis direction of the λ/2 plate and the absorption axis direction of the polarizer is preferably in a range of 75°±80, is more preferably in a range of 75°±6°, and is even more preferably in a range of 75°±3°. Further, at this time, the angle between the slow axis direction of the λ/4 plate and the absorption axis direction of the polarizing plate is preferably in a range of 15°±8°, is more preferably in a range of 15°±6°, and is even more preferably in a range of 15°±3°. It is preferable that the angle is in the range described above since the light leakage of the reflected light is able to be reduced to the extent of being invisible.

In addition, in a case where Rth of the λ/2 plate at a wavelength of 550 nm is positive, the angle between the slow axis direction of the λ/2 plate and the absorption axis direction of the polarizing plate is preferably in a range of 15°±8°, is more preferably in a range of 15°±60, and is even more preferably in a range of 15°±30. Further, at this time, the angle between the slow axis direction of the λ/4 plate and the absorption axis direction of the polarizing plate is preferably in a range of 75°±8°, is more preferably in a range of 75°±6°, and is even more preferably in a range of 75°+3°. It is preferable that the angle is in the range described above since the light leakage of the reflected light is able to be reduced to the extent of being invisible.

The material of the optically anisotropic support is not particularly limited. A polymer film which is able to be used as the material of the optically anisotropic support, for example, can be referred to paragraph 0030 of JP2012-108471A.

In a case where the λ/2 plate and the λ/4 plate are a laminate of the polymer film (a transparent support) and the optically anisotropic layer, it is preferable that the optically anisotropic layer includes at least one layer which is formed of a composition containing a liquid crystal compound. That is, it is preferable that the λ/2 plate and the λ/4 plate are a laminate of the polymer film (the transparent support) and the optically anisotropic layer formed of the composition containing the liquid crystal compound. A polymer film having small optical anisotropy may be used in the transparent support, or a polymer film exhibiting optical anisotropy by a stretching treatment or the like may be used. It is preferable that the support has light transmittance of greater than or equal to 80%.

The type of the liquid crystal compound to be used for forming the optically anisotropic layer which may be included in the λ/2 plate and the λ/4 plate is not particularly limited. The details thereof, for example, can be referred to paragraphs 0032 and 0033 of JP2012-108471A.

In general, the liquid crystal compound is able to be classified into a rod-like liquid crystal compound and a disk-like liquid crystal compound according to the shape thereof. Further, each of the rod-like liquid crystal compound and the disk-like liquid crystal compound has a low molecular type and a high molecular type. In general, the polymer indicates that the degree of polymerization is greater than or equal to 100 (Polymer Physics and Phase Transition Dynamics, written by Masao DOI, Page. 2, published by Iwanami Shoten, Publishers., 1992). In the present invention, any liquid crystal compound is able to be used, and it is preferable to use the rod-like liquid crystal compound or the disk-like liquid crystal compound. Two or more types of rod-like liquid crystal compounds, two or more types of disk-like liquid crystal compounds, or a mixture of the rod-like liquid crystal compound and the disk-like liquid crystal compound may be used. It is more preferable that the rod-like liquid crystal compound or the disk-like liquid crystal compound having a reactive group is used for forming the optically anisotropic layer, and it is even more preferable that at least one of the rod-like liquid crystal compound and the disk-like liquid crystal compound has two or more reactive groups in one liquid crystal molecule, from the viewpoint of enabling a change in temperature or humidity to decrease. The liquid crystal compound may be a mixture of two or more types of liquid crystal compounds, and in this case, it is preferable that at least one of the liquid crystal compounds has two or more reactive groups.

For example, a rod-like liquid crystal compound disclosed in JP1999-513019A (JP-H11-513019A) or JP2007-279688A is able to be preferably used as the rod-like liquid crystal compound, and for example, a discotic liquid crystal compound disclosed in JP2007-108732A or JP2010-244038A is able to be preferably used as the discotic liquid crystal compound, but the rod-like liquid crystal compound and the disk-like liquid crystal compound are not particularly limited.

In a case where the λ/2 plate and the λ/4 plate include the optically anisotropic layer containing the liquid crystal compound, the optically anisotropic layer may formed of one layer, or may be a laminate of two or more optically anisotropic layers.

The formation of the optically anisotropic layer, for example, can be referred to paragraphs 0035, 0201, and 0202 to 0211 of JP2012-108471A.

In-plane retardation (Re) of the transparent support (the polymer film) supporting the optically anisotropic layer is preferably 0 to 50 nm, is more preferably 0 to 30 nm, and is even more preferably 0 to 10 nm. It is preferable that the in-plane retardation (Re) is in the range described above since the light leakage of the reflected light is able to be reduced to the extent of being invisible.

In addition, it is preferable that retardation (Rth) of the support in the thickness direction described above is selected according to a combination with the optically anisotropic layer which is disposed on or under the support. Accordingly, the light leakage of the reflected light and shading at the time of being observed from the tilt direction are able to be reduced.

Examples of a polymer configuring the support include polymers disclosed in paragraph 0213 of JP2012-108471A. Among them, triacetyl cellulose, polyethylene terephthalate, and a polymer having an alicyclic structure are preferable, and the triacetyl cellulose is particularly preferable.

The thickness of the transparent support, for example, is approximately 10 μm to 200 μm, and is preferably 10 μm to 80 μm, and it is preferable that the thickness of the transparent support is 20 μm to 60 μm from the viewpoint of suppressing external light reflection. In addition, the transparent support may be formed by laminating a plurality of layers. It is preferable that the thickness of the transparent support is thin in order to suppress the reflection of external light. In order to improve adhesion between the transparent support and the optically anisotropic layer disposed on the transparent support, the transparent support may be subjected to a surface treatment (for example, a glow discharge treatment, a corona discharge treatment, an ultraviolet ray (UV) treatment, and a flame treatment). An adhesive layer (an undercoat layer) may be disposed on the transparent support. In addition, it is preferable that a transparent support or a transparent support in which a polymer layer mixed with inorganic particles having an average particle diameter of approximately 10 to 100 nm at a weight ratio of solid contents of 5% to 40% is applied onto one surface of the support or is co-cast with the support in order to apply slidability in a transporting step or to prevent a back surface from being bonded to the surface after being wound is used in the transparent support or a long transparent support.

Furthermore, in the above description, the λ/2 plate or the λ/4 plate having a laminate structure in which the optically anisotropic layer is disposed on the support has been described, but the present invention is not limited to the embodiment described above. The λ/2 plate and the λ/4 plate may be laminated on one surface of one transparency support, or the λ/2 plate may be laminated on one surface of one transparency support, and the λ/4 plate may be laminated on the other surface. Further, the λ/2 plate or the λ/4 plate may be formed only of a stretched polymer film (an optically anisotropic support), or may be formed only of a liquid crystal film which is formed of a composition containing a liquid crystalline compound. The details of the liquid crystal film are identical to the description with respect to the optically anisotropic layer described above.

It is preferable that the λ/2 plate and the λ/4 plate described above are continuously manufactured in a state of a long film. At this time, it is preferable that the slow axis angle of the λ/2 plate or the λ/4 plate is 15°±8° or 75° with respect to a longitudinal direction of the long film. Furthermore, in a case where the optically anisotropic layer is formed of a liquid crystalline compound, the angle of a slow axis of the optically anisotropic layer is able to be adjusted according to a rubbing angle. In addition, in a case where the λ/2 plate or the λ/4 plate is formed of a polymer film (an optically anisotropic support) which is subjected to a stretching treatment, the angle of the slow axis is able to be adjusted according to a stretching direction.

The brightness enhancement film including the reflection polarizer which allows circularly polarized light to exit has been described, and the reflection polarizer included in the brightness enhancement film of the embodiment I may allow linearly polarized light to exit. Examples of a preferred embodiment of the reflection polarizer allowing linearly polarized light to exit include a multi-layer film such as a multi-layer film of a birefringent material and a dielectric multi-layer film. It is preferable that the reflection polarizer allowing linearly polarized light to exit is a reflection polarizer which has a reflection center wavelength in a wavelength range of 430 to 480 nm, has a reflectivity peak having a half-width of less than or equal to 100 nm, and allows linearly polarized light to exit, a reflection polarizer which has a reflection center wavelength in a wavelength range of 500 to 600 nm, has a reflectivity peak having a half-width of less than or equal to 100 nm, and allows linearly polarized light to exit, and a reflection polarizer which has a reflection center wavelength in a wavelength range of 600 to 650 nm, has a reflectivity peak having a half-width of less than or equal to 100 nm, and allows linearly polarized light to exit. Even in a case where a reflection polarizer has one flat reflectivity peak which is approximately constant with respect to the wavelength in all of the wavelength ranges described above, the reflection polarizer is included in this embodiment. The number of laminated multi-layer films is able to be suitably changed in order to attain target reflectivity.

It is preferable that the multi-layer film to be used as the reflection polarizer is a multi-layer film which has a reflection center wavelength in a wavelength range of 430 to 480 nm and a reflectivity peak having a half-width of less than or equal to 100 nm, a multi-layer film which has a reflection center wavelength in a wavelength range of 500 to 600 nm and a reflectivity peak having a half-width of less than or equal to 100 nm, and a multi-layer film which has a reflection center wavelength in a wavelength range of 600 to 650 nm and a reflectivity peak having a half-width of less than or equal to 100 nm. That is, it is preferable that the multi-layer film does not have a reflectivity peak in a visible light range other than the reflectivity peak described above.

It is preferable that the film thickness of the multi-layer film described above is thin. The film thickness of the multi-layer film is preferably 5 to 100 μm, is more preferably 10 to 50 μm, and is particularly preferably 5 to 20 μm.

A manufacturing method of the multi-layer film described above is not particularly limited. For example, the multi-layer film is able to be manufactured with reference to methods disclosed in JP3187821B, JP3704364B, JP4037835B, JP4091978B, JP3709402B, JP4860729B, JP3448626B, and the like, and the contents of the publications are incorporated in the present invention. Furthermore, the multi-layer film described above may indicate a multi-layer reflection polarizing plate, or a birefringent interference polarizer of an alternating multi-layer film. Known examples are able to include DBEF (Product Name, manufactured by 3M Company).

Next, a brightness enhancement film according to the embodiment II will be described.

(Optically Functional Layer)

The brightness enhancement film according to the embodiment II includes an optically functional layer which performing light condensation or diffusion refracting incidence light. A lens layer or a prism layer, and a diffusion layer are used as the optically functional layer. The optically functional layer is bonded onto the support, for example, through an adhesive layer, and thus, it is possible to obtain the brightness enhancement film. Further, the brightness enhancement film is able to arbitrarily include other layers such as a hard coat layer. For example, the hard coat layer is laminated on one surface of the support, and the optically functional layer is laminated on the other surface, and thus, it is possible to obtain the brightness enhancement film according to the embodiment II.

In the prism layer, a plurality of prisms having a triangular sectional shape are formed at a constant pitch. In a case where light is incident from the support side, the brightness enhancement film including such an optically functional layer refracts incidence light ray towards a predetermined direction by the prism. Accordingly, the light exits in a light distribution having a large peak in a predetermined direction. For example, in a case where the incidence light ray is refracted towards a normal direction, light distribution having a large peak in the normal direction is obtained. Accordingly, it is possible to improve the front brightness of the liquid crystal display device.

The optically functional layer performs light condensation or diffusion with respect to the incidence light by refracting the light described above. Thus, the path of the light is controlled. The light is refracted by an incidence angle on the surface of the optically functional layer and a difference in the refractive index between the support and the optically functional layer, or the incidence light is refracted or reflected on an emission surface, and thus, the light properties thereof are further exhibited and used.

In a case where the optically functional layer is the lens layer, the lens layer is configured by arranging a plurality of lenses refracting light at a predetermined pitch. In a case where light exiting from the surface of the support is incident on the optically functional layer, the optically functional layer controls an exit angle of incidence light. Examples of the lens include a cylindrical lens in which a cylinder is divided into two parts in an axis direction, a triangular prism, a spherical lens, and a non-spherical lens, and the triangular prism may be used. Therefore, the optically functional layer which is the prism layer is also one type of lens layer.

The optically functional layer, the support, the hard coat layer, the adhesive layer, and the like described above are able to be prepared by a known method. In addition, the brightness enhancement film according to the embodiment I is also available as a commercially available product. Examples of the commercially available product are able to include a brightness enhancement film BEF SERIES (manufactured by 3M Company).

The liquid crystal panel according to one embodiment of the present invention is able to include two or more brightness enhancement films in order to further enhance brightness. For example, the brightness enhancement film according to the embodiment I and the brightness enhancement film according to the embodiment II are able to be arranged on the liquid crystal panel by being laminated.

In the liquid crystal panel described above, the liquid crystal panel member and the optical conversion member are integrally laminated, and thus in general, a layer included in the liquid crystal panel member also functions as a layer included in the optical conversion member, or the reverse configuration thereof is able to be obtained. For example, a protective film of the backlight side polarizing plate is able to have a function of a barrier layer protecting the optical conversion layer. On the contrary, the barrier layer of the optical conversion layer is also able to function as the protective film of the backlight side polarizing plate. According to such a configuration, it is possible to realize a reduction in the thickness and the weight of the liquid crystal display device.

[Liquid Crystal Display Device]

Another embodiment of the present invention relates to a liquid crystal display device including the liquid crystal panel described above, and a backlight unit including a light source. The details of the liquid crystal panel are as described above.

An edge light mode backlight and a direct backlight mode backlight are known as the backlight. The backlight unit included in the liquid crystal display device described above may be in any mode. In one embodiment, a light source which emits blue light having a light emission center wavelength in a wavelength range of 430 nm to 480 nm, for example, a blue light emitting diode which emits blue light is able to be used as the light source. In a case where the light source emitting the blue light is used, it is preferable that at least a quantum dot A emitting red light which is excited by excitation light and a quantum dot B emitting green light are contained in the optical conversion layer. Accordingly, it is possible to embody the white light by blue light which is emitted from the light source and is transmitted through the optical conversion member, and red light and green light which are emitted from the optical conversion member. As described above, in a case where the optical conversion member is disposed as the configuration member of the backlight unit, the extraction efficiency of the red light and the green light which perform internal light emission is locally changed due to the deformation of the liquid crystal panel, and thus, the color unevenness occurs, but according to one embodiment of the present invention, the occurrence of such color unevenness is able to be suppressed. Alternatively, in another embodiment, a light source which emits ultraviolet light having a light emission center wavelength in a wavelength range of 300 nm to 430 nm, for example, an ultraviolet light emitting diode is able to be used as the light source. In this case, it is preferable that a quantum dot C emitting blue light which is excited by excitation light is contained in the optical conversion layer along with the quantum dots A and B. Accordingly, it is possible to embody the white light by the red light, the green light, and the blue light which are emitted from the optical conversion member. Even in this case, the extraction efficiency of the light having each color which performs the internal light emission is locally changed due to the deformation of the liquid crystal panel in a case where the optical conversion member is disposed as the configuration member of the backlight unit, and thus, the color unevenness occurs, but according to one embodiment of the present invention, the occurrence of such color unevenness is able to be suppressed.

(Light Emission Wavelength)

It is preferable that a backlight unit which is a multi-wavelength light source is used as the backlight unit from the viewpoint of realizing a high brightness and a high color reproducibility. Preferred embodiments are able to include a backlight unit which emits blue light having a light emission center wavelength in a wavelength range of 430 to 480 nm and a light emission intensity peak having a half-width of less than or equal to 100 nm, green light having a light emission center wavelength in a wavelength range of 500 to 600 nm and a light emission intensity peak having a half-width of less than or equal to 100 nm, and red light having a light emission center wavelength in a wavelength range of 600 to 680 nm and a light emission intensity peak having a half-width of less than or equal to 100 nm.

The wavelength range of the blue light is preferably 450 to 480 nm, and is more preferably 460 to 470 nm, from the viewpoint of further improving brightness and color reproducibility.

The wavelength range of the green light is preferably 520 to 550 nm, and is more preferably 530 to 540 nm, from the same viewpoint.

In addition, the wavelength range of the red light is preferably 610 to 650 nm, and is more preferably 620 to 640 nm, from the same viewpoint.

All of the half-widths of the respective light emission intensities of the blue light, the green light, and the red light are preferably less than or equal to 80 nm, are more preferably less than or equal to 50 nm, are even more preferably less than or equal to 45 nm, are still more preferably less than or equal to 40 nm, from the same viewpoint. Among them, it is particularly preferable that the half-width of each of the light emission intensity of the blue light is less than or equal to 30 nm.

In one embodiment of the liquid crystal display device, the liquid crystal display device includes a liquid crystal cell in which a liquid crystal layer is interposed between facing substrates of which at least one includes an electrode, and the liquid crystal cell is configured by being arranged between two polarizing plates. The liquid crystal display device includes the liquid crystal cell in which a liquid crystal is sealed between upper and lower substrates, changes the alignment state of the liquid crystal by applying a voltage, and thus, displays an image. Further, as necessary, the liquid crystal display device includes an associated functional layer such as a polarizing plate protective film or an optical compensation member performing optical compensation, and an adhesive layer. In addition, a surface layer such as a forward scattering layer, a primer layer, an antistatic layer, and an undercoat layer may be arranged along with (or instead of) a color filter substrate, a thin layer transistor substrate, a lens film, a diffusion sheet, a hard coat layer, an anti-reflection layer, a low reflection layer, an antiglare layer, and the like.

(Touch Panel Substrate and Front Plate)

The liquid crystal display device is also able to include a touch panel substrate on the surface of the visible side polarizing plate. The liquid crystal display device including the touch panel substrate is able to be used as an input device. In addition, the front plate which is arranged in order to protect a display device may be arranged on the surface of the visible side polarizing plate.

The liquid crystal display device according to one embodiment of the present invention described above includes the optical conversion member having high quantum dot light emission efficiency, and thus, it is possible to realize high brightness and high color reproducibility.

(Polarizing Plate)

Another embodiment of the present invention relates to a polarizing plate in which a polarizer, and an optical conversion member including an optical conversion layer containing a quantum dot emitting fluorescent light which is excited by incident excitation light are integrally laminated. The details of the polarizing plate described above are as described above.

As with a general polarizing plate, the polarizing plate described above is bonded to the liquid crystal cell through a known adhesive layer or a known pressure sensitive adhesive layer, and thus, the liquid crystal display device is able to be configured. It is preferable that the polarizing plate described above is used as the backlight side polarizing plate of the liquid crystal display device. According to the polarizing plate described above, the optical conversion member is integrated, and thus, it is possible to suppress the color unevenness which occurs due to the deformation of the backlight side polarizer described above.

(Polarizing Plate Protective Film)

Another embodiment of the present invention relates to an optical conversion member including an optical conversion layer containing a quantum dot emitting fluorescent light which is excited by incident excitation light. The polarizing plate protective film described above includes at least the optical conversion layer, and thus, it is possible to prepare a polarizing plate having an optical conversion function of a quantum dot by bonding the polarizing plate protective film to the polarizing plate through a known adhesive layer or a known pressure sensitive adhesive layer.

It is preferable that the polarizing plate protective film described above includes at least a barrier layer on the surface of the polarizing plate protective film on a side opposite to the surface which is bonded to the polarizing plate. Accordingly, it is possible to prevent the deterioration of a quantum dot due to oxygen, moisture, or the like. The details of the barrier layer are as described above.

### EXAMPLES

Hereinafter, the characteristics of the present invention will be more specifically described with reference to examples. Materials, used amounts, ratios, treatment contents, treatment sequences, and the like of the following examples are able to be suitably changed unless the changes cause deviance from the gist of the present invention. Therefore, the range of the present invention will not be restrictively interpreted by the following specific examples.

Furthermore, in examples and comparative examples described below, a reflection polarizer and an optically functional layer which were obtained by disassembling a commercially available liquid crystal display device (Product Name: TH-L42D2 manufactured by Panasonic Corporation) were used as a reflection polarizer used as a brightness enhancement film (a DBEF film manufactured by 3M Company) and an optically functional layer (a BEF film manufactured by 3M Company).

### Comparative Example 1

### 1. Preparation of Quantum Dot-Containing Polymerizable Composition

0.54 ml of trimethylol propane acrylate, 2.4 ml of lauryl methacrylate, and Irgacure 819 manufactured by BASF SE as a photopolymerization initiator were mixed, and thus, a polymerizable composition was obtained.

A toluene dispersion of a quantum dot was added such that the concentration of each of a quantum dot A having a light emission peak in a wavelength range of 600 to 680 nm, and a quantum dot B having a light emission center wavelength in a short wavelength range from the quantum dot A and a light emission peak in a wavelength range of 500 to 600 nm became 0.5 mass % with respect to 100 mg of the obtained polymerizable composition, and reduced pressure drying was performed for 30 minutes. Stirring was performed until the quantum dot was dispersed, and thus, a dispersion (a quantum dot-containing polymerizable composition) was obtained.

### 2. Preparation of Optical Conversion Member QD1

The dispersion which was prepared in 1. described above was applied onto a glass plate such that the final film thickness became 280 μm, and thus, a photosensitive layer was formed on the glass plate.

A photosensitive layer was exposed at 5 J/cm² from an air surface side under a nitrogen atmosphere by using a UV exposure machine (EXECURE 3000W manufactured by HOYA CANDEO OPTRONICS CORPORATION), and the photosensitive layer described above was cured, and thus, an exposed film (a cured film) was obtained. After the exposure, the cured film was peeled off from the glass plate and was cut to have a size of 20 cm×15 cm, and thus, an optical conversion member 101 was obtained.

### 3. Preparation of Polarizing Plate P

Iodine was adsorbed in a stretched polyvinyl alcohol film according to Example 1 of JP2001-141926A, and thus, a polarizer having a film thickness of 20 μm was prepared.

A retardation film (TD80UL manufactured by Fujifilm Corporation) was bonded onto one surface of the prepared polarizer through a pressure sensitive adhesive.

One surface of a protective film prepared by the following method which had been subjected to a corona treatment was bonded onto the other surface polarizer, and thus, a polarizing plate P was obtained.

<Preparation of Protective Film>

A pellet of a mixture (Tg of 127° C.) of 90 parts by mass of a (meth)acrylic resin {Mass Ratio of Copolymerization Monomer=Methyl Methacrylate/Methyl 2-(Hydroxy Methyl) Acrylate=8/2, Lactone Ring Formation Rate of Approximately 100%, Content Ratio of Lactone Ring Structure of 19.4%, Mass Average Molecular Weight of 133,000, Melt Flow Rate of 6.5 g/10 minutes (240° C., 10 kgf), and Tg of 131° C.} having a lactone ring structure described below: and

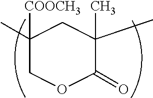

10 parts by mass of an acrylonitrile-styrene (AS)resin {TOYO AS AS20, manufactured by TOYO STYRENE Co., Ltd} was supplied to a biaxial extruder, and was subjected to melting extrusion into the shape of a sheet at 280° C., and thus, a (meth)acrylic resin sheet having a lactone ring structure was obtained. An un-stretched sheet was vertically and horizontally stretched under temperature conditions of 160° C., and thus, a thermoplastic resin film 1 (Thickness: 40 μm, In-Plane Retardation Re: 0.8 nm, and Retardation in Thickness Direction Rth: 1.5 nm) was obtained.

### 4. Preparation of Liquid Crystal Panel L21

Two polarizing plates P2 prepared in 3. described above were bonded to a liquid crystal cell for VA in crossed nicol arrangement as a visible side polarizing plate and a backlight side polarizing plate such that the retardation film was arranged on the liquid crystal cell side and the protective film was arranged on the outside by a pressure sensitive adhesive.

Accordingly, a liquid crystal panel L21 was obtained. The thickness of each of two glass substrates interposing a liquid crystal layer of the liquid crystal panel L1 therebetween was 0.42 mm.

### 5. Mounting on Liquid Crystal Display Device

A commercially available tablet type LCD (iPad (Registered Trademark) manufactured by Apple Inc.) was disassembled, a prism sheet and a diffusion sheet were taken out, and then, a filter transmitting only blue light was arranged between an LED module and a light guide plate attached to a reflection plate. Therefore, the blue light exited from a backlight unit, and was incident on a liquid crystal panel.

The liquid crystal panel was changed to the liquid crystal panel L21, and then, the optical conversion member 101 prepared in 1. described above was arranged between the liquid crystal cell and the light guide plate, and re-assembling was performed, and thus, a liquid crystal display device 101 was obtained.

### Example 1

### 1. Preparation of Liquid Crystal Panel L1 Attached with Optical Conversion Member

An easily adhesive layer was prepared on one surface of the optical conversion member QD1.

The easily adhesive layer of the optical conversion member QD1 was bonded onto the surface of the backlight side polarizing plate (the surface of the protective film) of the liquid crystal panel L21 prepared by the method described above by an acrylic pressure sensitive adhesive, and thus, a liquid crystal panel L1 attached with an optical conversion member was obtained.

### 2. Mounting on Liquid Crystal Display Device

A commercially available tablet type LCD (iPad (Registered Trademark) manufactured by Apple Inc.) was disassembled, a prism sheet and a diffusion sheet were taken out, and then, a filter transmitting blue light was arranged between an LED module and a light guide plate attached to a reflection plate.

The liquid crystal panel was changed to the liquid crystal panel L1, and then, re-assembling was performed, and thus, a liquid crystal display device 102 was obtained.

### Comparative Example 2

A liquid crystal display device 103 was obtained by the same method as that in Comparative Example 1 except that an optical conversion member QD2 including a barrier film on both surfaces, which was prepared by the following method, was used as the optical conversion member.

<Preparation of Optical Conversion Member QD2 Including Barrier Film on Both Surfaces>

1. Preparation of Barrier Film

(1) Preparation of Inorganic Film

A PET film (COSMOSHINE A4300 manufactured by TOYOBO CO., LTD., Thickness of 100 μm, and Refractive Index at Wavelength of 535 nm nu(535): 1.62) was used as a transparency substrate, and was arranged in a chamber of a magnetron sputtering device. Silicon nitride was used as a target, and film formation was performed in the following film formation conditions such that the film thickness of silicon oxynitride became 25 nm.

Film Formation Pressure: 2.5×10⁻¹ Pa

Argon Gas Flow Rate: 20 sccm

Nitrogen Gas Flow Rate: 9 sccm

Frequency: 13.56 MHz

Electric Power: 1.2 kW

(2) Preparation of Organic Film

A resin having a CARDO polymer containing a fluorene atom as a skeleton was applied on the inorganic film obtained in (1) described above by a spin coating method, and was heated at 160° C. for 1 hour, and thus, an organic film was formed. The film thickness of the organic film was 1 μm. Thus, a barrier film was obtained. Furthermore, the barrier properties of the obtained barrier film were measured by the method described above, and thus, oxygen permeability was less than or equal to 0.5 cm³/(m²·day), and water vapor permeability was less than or equal to 0.5 g/(m²·day).

(3) Bonding onto Optical Conversion Member

The prepared barrier film was bonded onto both surfaces of the optical conversion member QD1 (an optical conversion layer) through an acrylic pressure sensitive adhesive such that the inorganic layer was positioned on the optical conversion layer side and the organic layer was positioned on the outside, and thus, an optical conversion member QD2 including a barrier film on both surfaces was obtained.

### Example 2

A liquid crystal panel L2 and a liquid crystal display device 104 were obtained by the same method as that in Example 1 except that an optical conversion member QD2 including a barrier film on both surfaces, which was prepared by the method described above, was used as the optical conversion member.

### Example 3

A liquid crystal display device 106 was obtained by the same method as that in Example 2 except that a liquid crystal panel L3 was prepared by using a liquid crystal cell which was obtained by disassembling a tablet type LCD (iPad2 manufactured by Apple Inc.) as the liquid crystal cell. The thickness of each of two glass substrates interposing a liquid crystal layer of the liquid crystal panel therebetween was 0.25 mm.

### Comparative Example 3

A liquid crystal display device 105 was obtained by the same method as that in Comparative Example 2 except that a liquid crystal panel L22 was prepared by using the same liquid crystal cell as that of Example 3 as the liquid crystal cell.

### Comparative Example 4

An easily adhesive layer was formed on a reflection polarizer (a DBEF film manufactured by 3M Company).

A liquid crystal display device 107 was obtained by the same method as that in Comparative Example 2 except that a liquid crystal cell in which the thickness of each of two glass substrates interposing a liquid crystal layer therebetween was 0.25 mm was used as the liquid crystal cell, and a liquid crystal panel L23 was prepared by bonding the backlight side surface of the liquid crystal cell to an easily adhesive layer of a brightness enhancement film attached with an easily adhesive layer, which was formed by the method described above, through an acrylic pressure sensitive adhesive.

### Example 4

An easily adhesive layer was formed on an optically functional layer (a BEF film manufactured by 3M Company).

A liquid crystal cell L4 and a liquid crystal display device 108 were obtained by the same method as that in Example 1 except that a liquid crystal cell in which the thickness of each of two glass substrates interposing a liquid crystal layer therebetween was thickness 0.25 mm was used as the liquid crystal cell, the backlight side surface of the liquid crystal cell was bonded to easily adhesive layer of a brightness enhancement film attached with an easily adhesive layer, which was formed by the method described above, through an acrylic pressure sensitive adhesive, and the optical conversion member QD2 including a barrier film on both surfaces was bonded onto the surface of the BEF film through an acrylic pressure sensitive adhesive.

### Example 5

A liquid crystal cell L5 and a liquid crystal display device 109 were obtained by the same method as that in Example 4 except that a reflection polarizer (a DBEF film manufactured by 3M Company) was used instead of the optically functional layer.

### Example 6

A liquid crystal display device 110 was obtained by the same method as that in Example 1 except that a liquid crystal panel L6 prepared by the following method was used.

<Preparation of Liquid Crystal Panel L6>

1. Bonding of Liquid Crystal Cell and Polarizing Plate

Two polarizing plates P2 prepared by the method described above were bonded to a liquid crystal cell for VA in crossed nicol arrangement as a visible side polarizing plate and a backlight side polarizing plate such that the retardation film was arranged on the liquid crystal cell side and the protective film was arranged on the outside by a pressure sensitive adhesive. A liquid crystal cell which was obtained by disassembling 206SH manufactured by SHARP, by taking out only a liquid crystal cell, and then, by grinding two glass substrates interposing a liquid crystal layer therebetween such that the thickness of each of the two glass substrates was adjusted to be 0.25 mm was used as the liquid crystal cell for VA.

2. Preparation of Laminated Film Including λ/4 Plate and Reflection Polarizer (Cholesteric Liquid Crystal Layer)

As with paragraphs 0020 to 0033 of JP2003-262727A, two layers of liquid crystalline materials were applied onto a substrate of 40 μm, and were polymerized, and thus, a λ/4 plate was prepared.

In a λ/4 plate A, Re (450) was 110 nm, Re (550) was 135 nm, Re (630) was 140 nm, and the film thickness was 1.6 μm.

A first light reflection layer formed by immobilizing a cholesteric liquid crystalline phase, a second light reflection layer formed by immobilizing a cholesteric liquid crystalline phase, and a third light reflection layer formed by immobilizing a cholesteric liquid crystalline phase were formed on the λ/4 plate A according to coating, by changing the added amount of a chiral agent to be used with reference to paragraphs 0016 to 0148 of JP2013-203827A and Fuji Film Research & Development No. 50 (2005) pp. 60 to 63, and thus, a reflection polarizer was formed.

In the obtained first light reflection layer, the reflection center wavelength of the maximum reflectivity peak was 450 nm, the half-width was 40 nm, and the film thickness was 1.8 μm.

In the obtained second light reflection layer, the reflection center wavelength of the maximum reflectivity peak was 550 nm, the half-width was 50 nm, and the film thickness was 2.0 μm.

In the obtained third light reflection layer, the reflection center wavelength of the maximum reflectivity peak was 630 nm, the half-width was 60 nm, and the film thickness was 2.1 μm.

Furthermore, the average refractive index of the first light reflection layer, the second light reflection layer, and the third light reflection layer was 1.57.

The total thickness of the obtained λ/4 plate and the reflection polarizer was 47.5 μm. A commercially available prism sheet was bonded to the surface of the third light reflection layer surface of a laminate of the λ/4 plate and the reflection polarizer obtained as described above through a pressure sensitive adhesive, and thus, a laminated film A was obtained.

3. Preparation of Liquid Crystal Panel L6 Attached with Optical Conversion Member

The λ/4 plate of the laminated film A was bonded to the surface of the backlight side polarizing plate (the surface of the protective film) which has been bonded to the liquid crystal cell in 1. described above, through an acrylic pressure sensitive adhesive.

After that, the surface of the prism sheet of the laminated film A was bonded to the surface of the barrier layer of the optical conversion member QD2 including a barrier film on both surfaces, which was prepared by the method described above, through an acrylic pressure sensitive adhesive.

Accordingly, a liquid crystal panel L6 attached with an optical conversion member was obtained.

### Example 7

A liquid crystal panel L7 and a liquid crystal display device 111 were obtained by the same method as that in Example 4 except that an easily adhesive layer was formed on one surface of a reflection polarizer (a DBEF film manufactured by 3M Company) and an optically functional layer (a BEF film manufactured by 3M Company) was bonded to the other surface through an acrylic pressure sensitive adhesive.

### Example 8

A liquid crystal panel L8 and a liquid crystal display device 112 were obtained by the same method as that in Example 4 except that an optically functional layer (a BEF film manufactured by 3M Company) was bonded to the surface of the third light reflection layer through an acrylic pressure sensitive adhesive, and the surface of the optically functional layer was bonded to the surface of the barrier layer of the optical conversion member QD2 including a barrier film on both surfaces through an acrylic pressure sensitive adhesive.

### Example 9

### 1. Preparation of Optical Conversion Member QD3 Including Barrier Film on One Surface

An optical conversion member QD3 including a barrier film on one surface was prepared by the same method as that in the preparation of the optical conversion member QD2 except that the barrier layer was formed on only one surface.

A liquid crystal panel L9 and a liquid crystal display device 113 were obtained by the same method as that in Example 8 except that the surface of the optical conversion member QD3 on which the barrier layer was not disposed (the surface of the optical conversion layer) was bonded to the surface of the optically functional layer.

### Example 10

A liquid crystal panel L10 and a liquid crystal display device 114 were obtained by the same method as that in Example 2 except that the outside protective film of the backlight side polarizing plate was not disposed.

### Example 11

A liquid crystal panel L11 and a liquid crystal display device 115 were obtained by the same method as that in Example 5 except that the outside protective film of the backlight side polarizing plate was not disposed.

### Example 12

A liquid crystal panel L12 and a liquid crystal display device 116 were obtained by the same method as that in Example 6 except that the outside protective film of the backlight side polarizing plate was not disposed.

### Example 13

A liquid crystal panel L13 and a liquid crystal display device 117 were obtained by the same method as that in Example 7 except that the outside protective film of the backlight side polarizing plate was not disposed.

### Example 14

A liquid crystal panel L14 and a liquid crystal display device 118 were obtained by the same method as that in Example 8 except that the outside protective film of the backlight side polarizing plate was not disposed.

### Example 15

A liquid crystal panel L15 and a liquid crystal display device 119 were obtained by the same method as that in Example 9 except that the outside protective film of the backlight side polarizing plate was not disposed.

Evaluation Method

1. Color Unevenness Evaluation

The liquid crystal display devices of the examples and the comparative examples were retained under a high temperature and high humidity environment of a temperature of 60° C. and relative humidity of 90% for 48 hours, and then, were left to stand under an environment of a temperature of 25° C. and relative humidity of 60% for 2 hours, and then, a backlight of the liquid crystal display device was turned on. The grayness of 90 grayscales in 256 grayscales of the liquid crystal display device was displayed after 5 hours to 10 hours from the turning on of the backlight, a brightness meter (SR-3 manufactured by TOPCON CORPORATION) was disposed at a position, in which the an interval with respect to the liquid crystal panel was 700 mm, in a tilted viewing direction of a polar angle of 60° towards the liquid crystal panel (a direction of 60° from a normal direction of the surface of the liquid crystal panel) and an azimuthal angle of 45° (a direction of 45° in a counterclockwise direction by setting a long side direction of the surface of the liquid crystal panel as 0°), and the value of a change in the shade from the shade before being retained under a high temperature and high humidity environment was measured, and thus, the following evaluation grades were provided.

A: The value of the change in the shade was less than 3.0 (the change in the shade was hardly observed)

B: The value of the change in the shade was greater than or equal to 3.0 and less than 5.0 (the change in the shade was observed in a part of a region, but was in an allowable range)

C: The value of the change in the shade was greater than or equal to 5.0 and less than 9.0 (the change in the shade which was not in an allowable range was observed in a part of a region)

D: The value of the change in the shade was greater than or equal to 9.0 (the change in the shade which was not in an allowable range was observed in a wide region)

2. Evaluation of Reduction Rate of Color Unevenness

In the liquid crystal display device of each of the examples, a device for comparison was prepared in which an optical conversion member was arranged between a light guide plate and a liquid crystal panel without being bonded to a liquid crystal panel, color unevenness evaluation was performed as with 1. described above, and a device for evaluation was compared with the liquid crystal display devices of the examples, and thus, the reduction rate of the color unevenness was evaluated on the basis of the following criteria.

S: In the device for comparison, the change in the shade which was not in an allowable range was observed in a wide region, but in the corresponding liquid crystal display device of the example, the change in the shade was hardly observed.

A: In the device for comparison, the change in the shade which was not in an allowable range was observed in a part of a region, but in the corresponding liquid crystal display device of the example, the change in the shade was hardly observed.

The evaluation results described above are shown in Tables 1 and 2. Furthermore, the total thickness in the table is the total thickness of the liquid crystal panel. In addition, the configuration of the liquid crystal panel shown in the table schematically indicates a laminated state, and does not indicate the magnitude of the thickness of each layer.

TABLE 1

| | | Example/Comparative Example | | | | |
|---|---|---|---|---|---|---|
| | | Comparative | | Comparative | | Comparative |
| | | Example 1 | Example 1 | Example 2 | Example 2 | Example 3 |
| Configuration | Liquid Crystal | 101 | 102 | 103 | 104 | 105 |
| of Liquid | Display Device | | | | | |
| Crystal Display | Liquid Crystal | (Liquid Crystal | (Liquid Crystal | (Liquid Crystal | (Liquid Crystal | (Liquid Crystal |
| Device | Panel | Panel L21) | Panel L1) | Panel L21) | Panel L2) | Panel L22) |
| | | Protective | Protective | Protective | Protective | Protective |
| | | Film | Film | Film | Film | Film |
| | | Polarizer | Visible Side | Visible Side | Visible Side | Visible Side |
| | | | Polarizer | Polarizer | Polarizer | Polarizer |
| | | Retardation | Retardation | Retardation | Retardation | Retardation |
| | | Film | Film | Film | Film | Film |
| | | Pressure | Pressure | Pressure | Pressure | Pressure |
| | | Sensitive | Sensitive | Sensitive | Sensitive | Sensitive |
| | | Adhesive | Adhesive | Adhesive | Adhesive | Adhesive |
| | | Cell | Cell | Cell | Cell | Cell |
| | | Thickness of | Thickness of | Thickness of | Thickness of | Thickness of |
| | | each of Glass | each of Glass | each of Glass | each of Glass | each of Glass |
| | | Substrates | Substrates | Substrates | Substrates | Substrates |
| | | 0.42 mm | 0.42 mm | 0.42 mm | 0.42 mm | 0.25 mm |
| | | Pressure | Pressure | Pressure | Pressure | Pressure |
| | | Sensitive | Sensitive | Sensitive | Sensitive | Sensitive |
| | | Adhesive | Adhesive | Adhesive | Adhesive | Adhesive |
| | | Retardation | Retardation | Retardation | Retardation | Retardation |
| | | Film | Film | Film | Film | Film |
| | | Backlight Side | Backlight Side | Backlight Side | Backlight Side | Backlight Side |
| | | Polarizer | Polarizer | Polarizer | Polarizer | Polarizer |
| | | Protective | Protective | Protective | Protective | Protective |
| | | Film | Film | Film | Film | Film |
| | | | Pressure | | Pressure | |
| | | | Sensitive | | Sensitive | |
| | | | Adhesive | | Adhesive | |
| | | | Optical | | Optical | |
| | | | Conversion | | Conversion | |
| | | | Layer (Optical | | Member QD2 | |
| | | | Conversion | | Including | |
| | | | Member QD1) | | Barrier Film on | |
| | | | | | Both Surfaces | |
| | Optical | Optical | Absent | Optical | Absent | Optical |
| | Conversion | Conversion | | Conversion | | Conversion |
| | Member Arranged | Layer (Optical | | Member QD2 | | Member QD2 |
| | between Liquid | Conversion | | Including | | Including |
| | Crystal Panel | Member QD1) | | Barrier Film on | | Barrier Film on |
| | and Light | | | Both Surfaces | | Both Surfaces |
| | Guide Plate | | | | | |
| Integral Lamination of Liquid | | Absent | Present | Absent | Present | Absent |
| Crystal Panel Member and Optical | | | | | | |
| Conversion Member | | | | | | |
| Optically Functional Layer | | Absent | Absent | Absent | Absent | Absent |
| Evaluation | Color | C(8.2) | B(3.1) | C(8.2) | A(2.3) | D(10.8) |
| Result | Unevenness on | | | | | |
| | Display of | | | | | |
| | Intermediate | | | | | |
| | Grayscale ΔE | | | | | |
| | Reduction | — | A | — | A | — |
| | Rate of Color | | | | | |
| | Unevenness | | | | | |
| | Total | 1165 | 1180 | 1275 | 1290 | 944 |
| | Thickness | | | | | |
| | (μm) | | | | | |
| | | Example/Comparative Example | | | | |
| | | | Comparative | | | |
| | | Example 3 | Example 4 | Example 4 | Example 5 | Example 6 |
| Configuration | Liquid Crystal | 106 | 107 | 108 | 109 | 110 |
| of Liquid | Display Device | | | | | |
| Crystal Display | Liquid Crystal | (Liquid Crystal | (Liquid Crystal | (Liquid Crystal | (Liquid Crystal | (Liquid Crystal |
| Device | Panel | Panel L3) | Panel L23) | Panel L4) | Panel L5) | Panel L6) |
| | | Protective | Protective | Protective | Protective | Protective |
| | | Film | Film | Film | Film | Film |
| | | Visible Side | Visible Side | Visible Side | Visible Side | Visible Side |
| | | Polarizer | Polarizer | Polarizer | Polarizer | Polarizer |
| | | Retardation | Retardation | Retardation | Retardation | Retardation |
| | | Film | Film | Film | Film | Film |
| | | Pressure | Pressure | Pressure | Pressure | Pressure |
| | | Sensitive | Sensitive | Sensitive | Sensitive | Sensitive |
| | | Adhesive | Adhesive | Adhesive | Adhesive | Adhesive |
| | | Cell | Cell | Cell | Cell | Cell |
| | | Thickness of | Thickness of | Thickness of | Thickness of | Thickness of |
| | | each of Glass | each of Glass | each of Glass | each of Glass | each of Glass |
| | | Substrates | Substrates | Substrates | Substrates | Substrates |
| | | 0.25 mm | 0.25 mm | 0.25 mm | 0.25 mm | 0.25 mm |
| | | Pressure | Pressure | Pressure | Pressure | Pressure |
| | | Sensitive | Sensitive | Sensitive | Sensitive | Sensitive |
| | | Adhesive | Adhesive | Adhesive | Adhesive | Adhesive |
| | | Retardation | Retardation | Retardation | Retardation | Retardation |
| | | Film | Film | Film | Film | Film |
| | | Backlight Side | Backlight Side | Backlight Side | Backlight Side | Backlight Side |
| | | Polarizer | Polarizer | Polarizer | Polarizer | Polarizer |
| | | Protective | Protective | Protective | Protective | Protective |
| | | Film | Film | Film | Film | Film |
| | | Pressure | Pressure | Pressure | Pressure | Pressure |
| | | Sensitive | Sensitive | Sensitive | Sensitive | Sensitive |
| | | Adhesive | Adhesive | Adhesive | Adhesive | Adhesive |
| | | Optical | Reflection | Optically | Reflection | λ/4 Plate |
| | | Conversion | Polarizer | Functional | Polarizer | |
| | | Member QD2 | (DBEF) | Layer (BEF) | (DBEF) | |
| | | Including | | | | |
| | | Barrier Film | | | | |
| | | on Both | | | | |
| | | Surfaces | | | | |
| | | | | Pressure | Pressure | Reflection |
| | | | | Sensitive | Sensitive | Polarizer |
| | | | | Adhesive | Adhesive | (Cholesteric |
| | | | | | | Liquid Crystal |
| | | | | | | Layer) |
| | | | | Optical | Optical | Pressure |
| | | | | Conversion | Conversion | Sensitive |
| | | | | Member QD2 | Member QD2 | Adhesive |
| | | | | Including | Including | |
| | | | | Barrier Film on | Barrier Film on | |
| | | | | Both Surfaces | Both Surfaces | |
| | | | | | | Optical |
| | | | | | | Conversion |
| | | | | | | Member QD2 |
| | | | | | | Including |
| | | | | | | Barrier Film on |
| | | | | | | Both Surfaces |
| | Optical | Absent | Optical | Absent | Absent | Absent |
| | Conversion | | Conversion | | | |
| | Member Arranged | | Member QD2 | | | |
| | between Liquid | | Including | | | |
| | Crystal Panel | | Barrier Film on | | | |
| | and Light | | Both Surfaces | | | |
| | Guide Plate | | | | | |
| Integral Lamination of Liquid | | Present | Absent | Present | Present | Present |
| Crystal Panel Member and Optical | | | | | | |
| Conversion Member | | | | | | |
| Optically Functional Layer | | Absent | Present | Present | Present | Present |
| Evaluation | Color | A(2.5) | D | A(2.4) | A(2.3) | A(2.4) |
| Result | Unevenness on | | | | | |
| | Display of | | | | | |
| | Intermediate | | | | | |
| | Grayscale ΔE | | | | | |
| | Reduction | S | — | S | S | S |
| | Rate of Color | | | | | |
| | Unevenness | | | | | |
| | Total | 959 | 985 | 1143 | 1000 | 1024 |
| | Thickness | | | | | |
| | (μm) | | | | | |

TABLE 2

| | | Example/Comparative Example | | | | |
|---|---|---|---|---|---|---|
| | | Example 7 | Example 8 | Example 9 | Example 10 | Example 11 |
| Configuration | Liquid Crystal | 111 | 112 | 113 | 114 | 115 |
| of Liquid | Display Device | | | | | |
| Crystal Display | Liquid Crystal | (Liquid Crystal | (Liquid Crystal | (Liquid Crystal | (Liquid Crystal | (Liquid Crystal |
| Device | Panel | Panel L7) | Panel L8) | Panel L9) | Panel L10) | Panel L11) |
| | | Protective | Protective | Protective | Protective | Protective |
| | | Film | Film | Film | Film | Film |
| | | Visible Side | Visible Side | Visible Side | Visible Side | Visible Side |
| | | Polarizer | Polarizer | Polarizer | Polarizer | Polarizer |
| | | Retardation | Retardation | Retardation | Retardation | Retardation |
| | | Film | Film | Film | Film | Film |
| | | Pressure | Pressure | Pressure | Pressure | Pressure |
| | | Sensitive | Sensitive | Sensitive | Sensitive | Sensitive |
| | | Adhesive | Adhesive | Adhesive | Adhesive | Adhesive |
| | | Cell | Cell | Cell | Cell | Cell |
| | | Thickness of | Thickness of | Thickness of | Thickness of | Thickness of |
| | | each of Glass | each of Glass | each of Glass | each of Glass | each of Glass |
| | | Substrates | Substrates | Substrates | Substrates | Substrates |
| | | 0.25 mm | 0.25 mm | 0.25 mm | 0.25 mm | 0.25 mm |
| | | Pressure | Pressure | Pressure | Pressure | Pressure |
| | | Sensitive | Sensitive | Sensitive | Sensitive | Sensitive |
| | | Adhesive | Adhesive | Adhesive | Adhesive | Adhesive |
| | | Retardation | Retardation | Retardation | Retardation | Retardation |
| | | Film | Film | Film | Film | Film |
| | | Backlight Side | Backlight Side | Backlight Side | Backlight Side | Backlight Side |
| | | Polarizer | Polarizer | Polarizer | Polarizer | Polarizer |
| | | Protective | Protective | Protective | Pressure | Reflection |
| | | Film | Film | Film | Sensitive | Polarizer |
| | | | | | Adhesive | (DBEF) |
| | | Pressure | Pressure | Pressure | Optical | Pressure |
| | | Sensitive | Sensitive | Sensitive | Conversion | Sensitive |
| | | Adhesive | Adhesive | Adhesive | Member QD2 | Adhesive |
| | | | | | Including | |
| | | | | | Barrier Film on | |
| | | | | | Both Surfaces | |
| | | Reflection | λ/4 Plate | λ/4 Plate | | Optical |
| | | Polarizer | | | | Conversion |
| | | (DBEF) | | | | Member QD2 |
| | | | | | | Including |
| | | | | | | Barrier Film on |
| | | | | | | Both Surfaces |
| | | Optically | Reflection | Reflection | | |
| | | Functional | Polarizer | Polarizer | | |
| | | Layer (BEF) | (Cholesteric | (Cholesteric | | |
| | | | Liquid Crystal | Liquid Crystal | | |
| | | | Layer) | Layer) | | |
| | | Pressure | Optically | Optically | | |
| | | Sensitive | Functional | Functional | | |
| | | Adhesive | Layer (BEF) | Layer (BEF) | | |
| | | Optical | Pressure | Pressure | | |
| | | Conversion | Sensitive | Sensitive | | |
| | | Member QD2 | Adhesive | Adhesive | | |
| | | Including | | | | |
| | | Barrier Film on | | | | |
| | | Both Surfaces | | | | |
| | | | Optical | Optical | | |
| | | | Conversion | Conversion | | |
| | | | Member QD2 | Member QD3 | | |
| | | | Including | Including | | |
| | | | Barrier Film on | Barrier Film on | | |
| | | | Both Surfaces | One Surface | | |
| | Optical | Absent | Absent | Absent | Absent | Absent |
| | Conversion | | | | | |
| | Member Arranged | | | | | |
| | between Liquid | | | | | |
| | Crystal Panel | | | | | |
| | and Light | | | | | |
| | Guide Plate | | | | | |
| Integral Lamination of Liquid | | Present | Present | Present | Present | Present |
| Crystal Panel Member and Optical | | | | | | |
| Conversion Member | | | | | | |
| Optically Functional Layer | | Present | Present | Present | Absent | Present |
| Evaluation | Color | A(2.1) | A(2.6) | A(2.7) | A(2.4) | A(2.6) |
| Result | Unevenness on | | | | | |
| | Display of | | | | | |
| | Intermediate | | | | | |
| | Grayscale ΔE | | | | | |
| | Reduction Rate | S | S | S | S | S |
| | of Color | | | | | |
| | Unevenness | | | | | |
| | Total | 1184 | 1207 | 1152 | 904 | 945 |
| | Thickness | | | | | |
| | (μm) | | | | | |

| | | Example/Comparative Example | | | |
|---|---|---|---|---|---|
| | | Example 12 | Example 13 | Example 14 | Example 15 |
| Configuration | Liquid Crystal | 116 | 117 | 118 | 119 |
| of Liquid | Display Device | | | | |
| Crystal Display | Liquid Crystal | (Liquid Crystal | (Liquid Crystal | (Liquid Crystal | (Liquid Crystal |
| Device | Panel | Panel L12) | Panel L13) | Panel L14) | Panel L15) |
| | | Protective | Protective | Protective | Protective |
| | | Film | Film | Film | Film |
| | | Visible Side | Visible Side | Visible Side | Visible Side |
| | | Polarizer | Polarizer | Polarizer | Polarizer |
| | | Retardation | Retardation | Retardation | Retardation |
| | | Film | Film | Film | Film |
| | | Pressure | Pressure | Pressure | Pressure |
| | | Sensitive | Sensitive | Sensitive | Sensitive |
| | | Adhesive | Adhesive | Adhesive | Adhesive |
| | | Cell | Cell | Cell | Cell |
| | | Thickness of | Thickness of | Thickness of | Thickness of |
| | | each of Glass | each of Glass | each of Glass | each of Glass |
| | | Substrates | Substrates | Substrates | Substrates |
| | | 0.25 mm | 0.25 mm | 0.25 mm | 0.25 mm |
| | | Pressure | Pressure | Pressure | Pressure |
| | | Sensitive | Sensitive | Sensitive | Sensitive |
| | | Adhesive | Adhesive | Adhesive | Adhesive |
| | | Retardation | Retardation | Retardation | Retardation |
| | | Film | Film | Film | Film |
| | | Backlight Side | Backlight Side | Backlight Side | Backlight Side |
| | | Polarizer | Polarizer | Polarizer | Polarizer |
| | | λ/4 Plate | Reflection | λ/4 Plate | λ/4 Plate |
| | | | Polarizer | | |
| | | | (DBEF) | | |
| | | Reflection | Optically | Reflection | Reflection |
| | | Polarizer | Functional | Polarizer | Polarizer |
| | | (Cholesteric | Layer (BEF) | (Cholesteric | (Cholesteric |
| | | Liquid Crystal | | Liquid Crystal | Liquid Crystal |
| | | Layer) | | Layer) | Layer) |
| | | Pressure | Pressure | Optically | Optically |
| | | Sensitive | Sensitive | Functional | Functional |
| | | Adhesive | Adhesive | Layer (BEF) | Layer (BEF) |
| | | Optical | Optical | Pressure | Pressure |
| | | Conversion | Conversion | Sensitive | Sensitive |
| | | Member QD2 | Member QD2 | Adhesive | Adhesive |
| | | Including | Including | | |
| | | Barrier Film on | Barrier Film on | | |
| | | Both Surfaces | Both Surfaces | | |
| | | | | Optical | Optical |
| | | | | Conversion | Conversion |
| | | | | Member QD2 | Member QD3 |
| | | | | Including | Including |
| | | | | Barrier Film on | Barrier Film on |
| | | | | Both Surfaces | One Surface |
| | Optical | Absent | Absent | Absent | Absent |
| | Conversion | | | | |
| | Member Arranged | | | | |
| | between Liquid | | | | |
| | Crystal Panel | | | | |
| | and Light | | | | |
| | Guide Plate | | | | |
| Integral Lamination of Liquid | | Present | Present | Present | Present |
| Crystal Panel Member and Optical | | | | | |
| Conversion Member | | | | | |
| Optically Functional Layer | | Present | Present | Present | Present |
| Evaluation | Color | A(2.6) | A(2.1) | A(2.3) | A(2.6) |
| Result | Unevenness on | | | | |
| | Display of | | | | |
| | Intermediate | | | | |
| | Grayscale ΔE | | | | |
| | Reduction Rate | S | S | S | S |
| | of Color | | | | |
| | Unevenness | | | | |
| | Total | 969 | 1129 | 1152 | 1097 |
| | Thickness | | | | |
| | (μm) | | | | |

Evaluation Result

From the results shown in Tables 1 and 2, in the liquid crystal display devices of the examples using the liquid crystal panel in which the optical conversion member is integrally laminated on the backlight side surface of the liquid crystal panel member, it is possible to confirm that the occurrence of color unevenness after being retained under a high temperature and high humidity environment is suppressed. In addition, a reduction in the color unevenness was remarkable in the example where the thickness of the glass substrates interposing the liquid crystal cell therebetween was thin.

### INDUSTRIAL APPLICABILITY

The present invention is useful for a manufacturing field of a liquid crystal display device.

What is claimed is:

1. A liquid crystal panel, comprising:
a liquid crystal panel member including a visible side polarizer, a liquid crystal cell, and a backlight side polarizer; and
an optical conversion member including an optical conversion layer containing a quantum dot emitting fluorescent light which is excited by incident excitation light,
wherein the optical conversion member is integrally laminated on a backlight side surface of the liquid crystal panel member.

2. The liquid crystal panel according to claim 1,
wherein the optical conversion member includes at least one barrier layer.

3. The liquid crystal panel according to claim 1, further comprising:
a brightness enhancement film,
wherein the backlight side polarizer, the brightness enhancement film, and the optical conversion layer are provided in this order.

4. The liquid crystal panel according to claim 3,
wherein the brightness enhancement film includes a reflection polarizer including a cholesteric liquid crystal layer allowing circularly polarized light to exit, and further includes a λ/4 plate between the reflection polarizer and the backlight side polarizer.

5. The liquid crystal panel according to claim 3,
wherein the brightness enhancement film includes a reflection polarizer allowing linearly polarized light to exit.

6. The liquid crystal panel according to claim 3,
wherein the brightness enhancement film includes an optically functional layer performing light condensation or diffusion by refracting incidence light.

7. The liquid crystal panel according to claim 3,
wherein the liquid crystal panel includes two or more brightness enhancement films.

8. The liquid crystal panel according to claim 2, further comprising:
a brightness enhancement film,
wherein the backlight side polarizer, the brightness enhancement film, and the optical conversion layer are provided in this order.

9. The liquid crystal panel according to claim 8,
wherein the brightness enhancement film includes a reflection polarizer including a cholesteric liquid crystal layer allowing circularly polarized light to exit, and further includes a λ/4 plate between the reflection polarizer and the backlight side polarizer.

10. The liquid crystal panel according to claim 8,
wherein the brightness enhancement film includes a reflection polarizer allowing linearly polarized light to exit.

11. The liquid crystal panel according to claim 8,
wherein the brightness enhancement film includes an optically functional layer performing light condensation or diffusion by refracting incidence light.

12. The liquid crystal panel according to claim 8,
wherein the liquid crystal panel includes two or more brightness enhancement films.

13. The liquid crystal panel according to claim 1,
wherein the liquid crystal cell includes two substrates, and a liquid crystal layer positioned between the two substrates, and
each of the two substrates has a thickness of less than or equal to 0.3 mm.

14. The liquid crystal panel according to claim 2,
wherein the liquid crystal cell includes two substrates, and a liquid crystal layer positioned between the two substrates, and
each of the two substrates has a thickness of less than or equal to 0.3 mm.

15. The liquid crystal panel according to claim 3,
wherein the liquid crystal cell includes two substrates, and a liquid crystal layer positioned between the two substrates, and
each of the two substrates has a thickness of less than or equal to 0.3 mm.

16. The liquid crystal panel according to claim 1,
wherein the optical conversion layer contains at least a quantum dot A having a light emission center wavelength in a wavelength range of 600 nm to 680 nm, and
a quantum dot B having a light emission center wavelength in a wavelength range of 500 nm to 600 nm.

17. A liquid crystal display device, comprising:
the liquid crystal panel according to claim 1; and
a backlight unit including a light source.

18. The liquid crystal display device according to claim 17,
wherein the light source has a light emission center wavelength in a wavelength range of 430 nm to 480 nm.

19. A polarizing plate, comprising:
a polarizer; and
an optical conversion member including an optical conversion layer containing a quantum dot emitting fluorescent light which is excited by incident excitation light,
wherein the polarizer and the optical conversion member are integrally laminated.

20. A polarizing plate protective film, comprising:
an optical conversion member including an optical conversion layer containing a quantum dot emitting fluorescent light which is excited by incident excitation light.
